(19) United States
(12) Patent Application Publication
(10) Pub. No.: US 2020/0333782 A1
(43) Pub. Date: Oct. 22, 2020

(54) METHOD AND SYSTEM FOR AGRICULTURE

(71) Applicant: Xihelm Limited, Poole (GB)

(72) Inventors: James KENT, Poole (GB); Arthur Jack RUSSELL, Poole (GB); Fred ISAAC, Poole (GB)

(73) Assignee: Xihelm Limited, Poole (GB)

(21) Appl. No.: 16/960,902

(22) PCT Filed: Jan. 4, 2019
(86) PCT No.: PCT/GB2019/050020

§ 371 Date: Jul. 9, 2020

(30) Foreign Application Priority Data
Jan. 10, 2018 (GB) 1800404.4

(51) Int. Cl. G05D 1/00; A01G 9/14; A01D 46/30; A01D 93/00; G05D 1/02; A01D 90/16

(52) U.S. Cl. CPC G05D 1/0027; A01G 9/14; A01D 46/30; A01D 93/00; G05D 2201/0201; G05D 1/0044; G05D 1/0246; G05D 1/0278; A01D 90/16; G05D 1/0022

(57) ABSTRACT

A method (2000) of operating on crops (14) in a target area (20), comprising: using one or more sensors (1306), capturing (2200) data related to crops in a target area; mapping (2400) locations of the crops in the target area using the captured sensor data; generating (2600) one or more routes between at least some of the crops in the target area based on the mapped locations; and routing (2800) one or more operating units (1200) along the one or more routes thereby to operate on at least one of the crops.

The present invention relates to a method and system for operating on crops in a target area. The invention extends to an operating unit, a transport unit, a mapping unit, a maintenance unit, a dock, and a modified growing environment for use with such a method and system.

Various automated systems exist to perform tasks across agriculture, including picking fruit or other crops. However, such automated systems are not viable for widespread use, due to the fact that they are imprecise, slow, and often cause damage to crops.

Aspects and embodiments of the present invention are set out in the appended claims. These and other aspects and embodiments of the invention are also described herein.

According to an aspect of the invention, there is provided a method of operating on crops in a target area, comprising using one or more sensors, capturing data related to crops in a target area; mapping locations of the crops in the target area using the captured sensor data; generating one or more routes between at least some of the crops in the target area based on the mapped locations; and routing one or more operating units (i.e. an autonomous robot for performing specific operations, in particular harvesting, on crops) along the one or more routes thereby to operate on at least one of the crops on the one or more routes.

This may allow more efficient movement of autonomous operating units through a target area in a growing environment (which is dynamic and continuously-changing), which may thereby provide improved speed of harvesting and improved yield.

Optionally, capturing data related to crops in a target area comprises routing one or more mapping units through or around the target area; wherein the one or more mapping units comprise the one or more sensors.

Indications of location from the one or more mapping units may be received; wherein mapping locations of crops in a target area may comprise locating crops in relation to the one or more mapping units.

Mapping locations of crops in a target area may comprise locating crops in relation to the locations at a particular time of the one or more mapping units.

Optionally, the method may further comprise determining when to route the one or more mapping units through or around the target area. Said determining may be in dependence on one or more of: a schedule; detected issues with the mapped locations of crops and/or generated routes; and observed or expected events associated with the growing environment.

Mapping locations of crops in a target area may comprise selecting a speed of movement of the one or more mapping units based on a predetermined quality requirement for the captured data.

Routing one or more mapping units through or around the target area may comprise navigating through or around the target area using the one or more sensors of the one or more mapping units, optionally on the basis of a predetermined map of the target area. Routing one or more mapping units through or around the target area may comprise following a predetermined path through or around the target area using the one or more sensors of the one or more mapping units.

The one or more mapping units may be the one or more operating units, or alternatively the one or more mapping units may be different from the one or more operating units. The one or more mapping units are optionally configurable for use as the one or more operating units, and vice versa.

Mapping locations of crops in a target area may further comprise locating the crops in relation to a known plan of the target area. The method may further comprise receiving the plan of the target area.

Optionally, mapping locations of the crops in the target area comprises identifying crops in the captured data. Mapping locations of the crops in the target area may comprise identifying crops in the captured data using a trained model. Previously mapped locations of the crops in the target area may be used as feedback for the trained model.

Mapping locations of crops may comprise generating a map of the located crops; the map may be a three dimensional map of the located crops. Optionally, the three dimensional map is stored as a point cloud.

The one or more operating units may be used to obtain a measure associated with the practical difficulty of operating on crops in at least part of the target area; the measure may then be incorporated into the generated map. The mapped locations of the crops in the target area may be updated based on a previously generated map and an expected growth rate; optionally wherein said updating is further based on measured conditions in the growing environment. Previously generated maps may be incorporated into the generated map.

Mapping locations of crops in a target area optionally comprises using historic mapped locations to assist in identifying crops in data captured by the mapping unit.

The captured data may be used to classify the crops. A plurality of maps relating to different classifications of crops may be generated.

The one or more sensors may comprise one or more cameras; and the captured data may be visual data. The one or more cameras may comprise a camera suitable for range imaging.

The one or more routes may be efficient routes between at least some of the crops in the target area. Each operating unit may comprise a mobile cart; and one or more crop manipulation devices mounted on the cart for operating on crops. Routing one or more operating units along the one or more routes may comprise directing the movement of the cart; and directing the movement of the one or more crop manipulation devices.

Generating one or more routes may be further based on known parameters of the one or more operating units. The known parameters may comprise one or more typical speeds and/or times for the one or more operating units to perform one or more particular actions. The one or more particular actions may comprise one or more of: movement of the cart; and movement of the one or more crop manipulation devices. The crop manipulation devices may comprise robotic arms.

Generating the one or more routes optionally comprises determining an order in which at least some of the crops in the target area are to be harvested.

The one or more routes may be generated using a trained model. Generating routes may comprise using one or more of: visibility graphs; random-exploring algorithms; probabilistic road maps; optimal search algorithms; following by example; and bioinspired algorithms. The one or more routes may be assigned to the one or more operating units. Optionally, the method further comprises re-generating and/or re-assigning the one or more routes in dependence on detected issues with the one or more routes and/or the one or more operating units. Generating one or more routes may be in dependence on one or more predetermined performance metrics.

Operating on at least one of the crops may comprise harvesting at least one of the crops. At the location of each crop on the one or routes for a particular operating unit, a picking tool of the operating unit may be directed to the crop; and the crop may be harvested. Harvesting the crop may comprise one of: separating a crop-supporting part of a plant from the rest of the plant; and separating the crop from a plant.

The one or more operating units may be used to determine whether a particular crop on the one or more routes is ready for harvesting, wherein the particular crop is harvested based on an outcome of said determination. Determining whether a particular crop is ready to be harvested may comprise collecting data related to the particular crop using a sensor.

The captured data related to crops in a target area may be used to determine whether a particular crop in the target area is ready for harvesting, wherein the particular crop may be harvested based on an outcome of said determination. Determining whether a particular crop is ready to be harvested may further comprise comparing the collected data against a predetermined classifier relating to the readiness for harvest of crops.

Alternatively, the one or more operating units may be arranged to harvest all of the crops on the one or more routes and/or in the target area.

Data related to crops may be collected using one or more sensors of the one or more operating units; and the crops may be classified in dependence on data collected via said sensors.

The harvested crops may be stored on the one or more operating units. The harvested crops may be transported to a location for collection of the harvested crops. Transporting the harvested crops to a location for collection of the harvested crops optionally comprises directing one or more transport units to the one or more operating units; transferring harvested crops onto the one or more transport units; and directing the one or more transport units to the location for collection of the harvested crops.

Use of the one or more transport units may be scheduled. Optionally, the method further comprises weighing and/or sorting the harvested crops. Harvested crops may be classified according to weight and/or readiness for harvest.

Operating on crops may comprise one or more of: trimming; pruning; applying pesticides; planting; replanting; maintaining; clearing debris; and releasing bees.

The method may further comprise receiving a transmitted status from the one or more operating units; wherein the transmitted status relates to one or more of: location; load status; battery status; and errors or faults. In response to the transmitted status, one or more of the following actions may be performed: rerouting the one or more operating units; directing the one or more transport units to the one or more operating units; directing the one or more operating units to a charging point; and directing one or more maintenance units to the one or more operating units.

The method optionally further comprises routing one or more operating units along the one or more routes thereby to operate continuously on one or more of the crops on the one or more routes until a predetermined threshold is exceeded, wherein the threshold relates to one or more of: storage capacity; battery charge; maintenance status; and location within a route. The use of the one or more operating units may be scheduled, optionally using a trained model. Said scheduling may be in dependence on an external input, optionally wherein the external input is an indication of demand for crops.

The crops may be harvested in a growing environment, optionally wherein the growing environment is a greenhouse having a pipe-rail heating system. The target area may be the entire growing environment. The method may further comprise mapping the location of other objects of interest in a target area; wherein the other objects of interest are one or more of: obstacles; and parts of plants bearing the crops.

According to at least one aspect described herein, there is provided an operating unit for operating on crops in a growing environment, comprising: a powered cart; one or more robotic arms mounted on the cart, each arm having an end-effector for use in operating on crops; and a processor for controlling movement of the cart and movement of the one or more robotic arms; wherein the one or more robotic arms are arranged to position the end-effector with less than six degrees of freedom.

Optionally, the one or more robotic arms each have three axes of movement. The one or more robotic arms may comprise cylindrical robotic arms or Cartesian robotic arms.

The operating unit may further comprise one or more sensors for receiving data relating to surrounding objects; wherein said data may be used by the processor for navigating the cart through the growing environment. The one or more sensors may comprise a camera, wherein the processor may be configured to use computer vision to navigate the cart through the growing environment. Optionally, the operating unit is arranged to move through or around a target area in the growing environment while capturing data thereby to map the target area.

The data may be used by the processor for fine positioning of the one or more robotic arms. The data may be used by the processor and/or an external processor to determine whether a particular crop in the target area is ready for harvesting, optionally on the basis of a comparison against a predetermined classifier relating to the readiness for harvest of crops.

At least one of said one or more sensors may be mounted on the one or more robotic arms. The operating unit may further comprise one or more odometers, wherein data received from said odometers is used by the processor for navigating the cart through the growing environment

A data store may be provided in communication with the processor. The data store may comprise a model of the surroundings of the operating unit, optionally wherein the model includes a map of crops in a target area, wherein the processor is capable of using the model to control the movement of the cart and/or the one or more robotic arms. The data store may comprise instructions for the operating unit, the instructions comprising: one or more routes for movement of the movement of the cart and/or the one or more robotic arms; and operation instructions for one or more crops.

The operating unit may comprise a plurality of end effectors which are generally interchangeable for use with the one or more robotic arms. Possible operations on one or more crops may comprise one or more of: harvesting the one or more crops; trimming; pruning; applying pesticides; planting; replanting; maintaining; clearing debris; and releasing bees. Harvesting may comprise one or more of: picking; cutting; grinding; squeezing; crushing; and shaking.

The operating unit may further comprise means for storing harvested crops, preferably wherein the means for storing harvested crops is refrigerated, and optionally wherein the means for storing includes means for weighing and sorting the crops. The operating unit may further comprise means or co-operating with a further unit or storage mechanism to allow crops to be offloaded.

The operating unit may further comprise communication means in communication with the processor, wherein the operating unit may be arranged to transmit data related to operation on crops to an external server and receive data from the external server.

The operating unit may be configured to operate in accordance with a predetermined schedule. The operating unit may further comprise a GPS receiver; optionally wherein the operating unit is arranged to transmit an indication of location to a server. The operating unit may further comprise one or more light sources and/or a battery for powering the operating unit.

According to at least one aspect described herein, there is provided a mapping unit for capturing data related to crops in a target area in a growing environment, comprising: a powered cart; a processor for controlling movement of the cart; and one or more sensors mounted on the cart; wherein the mapping unit is arranged to move through or around a target area in the growing environment while capturing data using the one or more sensors thereby to capture data related to crops in a target area.

The one or more sensors may be arranged to be capable of capturing visual data from more than one side of the cart. The one or more sensors may be movable and/or mounted on a movable platform on the cart.

The mapping unit may comprise a plurality of sensors. The one or more sensors may comprise a camera; optionally a camera suitable for range imaging.

Captured data may be further used by the processor for navigating the cart through the growing environment; optionally using computer vision. The mapping unit may further comprise one or more odometers, wherein data received from said odometers is used by the processor for navigating the cart through the growing environment. The mapping unit may be configured to operate in accordance with a predetermined schedule.

The mapping unit may further comprise a battery for powering the mapping unit and/or one or more light sources. The mapping unit may further comprise communication means in communication with the processor; wherein the operating unit is arranged to transmit captured data to a server. The mapping unit may further comprise a GPS receiver; optionally wherein the operating unit is arranged to transmit an indication of location to a server.

According to at least one aspect described herein, there is provided a system for mapping locations of crops in a target area; comprising: one or more mapping units as described herein; and a server; wherein the server is configured to identify crops in the visual data captured by the one or more mapping units and locate the identified crops in relation to a known plan of the target area and/or the locations of the one or more mapping units thereby to map the location of crops in the target area.

According to at least one aspect described herein, there is provided a transport unit for transporting harvested crops in a growing environment, comprising: a powered cart; a processor for controlling movement of the cart; and one or more containers for transporting crops; wherein the transport unit is configured to shuttle between a generally variable first location and a generally fixed second location thereby to transport harvested crops from the first location to the second location. The generally variable first location may be the location of an operating unit, optionally an operating unit as described herein.

The transport unit may further comprise means for co-operating with the operating unit to assist in transferring crops from the operating unit to the transport unit. The transport unit may further comprise comprising wireless communication means for receiving an indication of location from the operating unit, optionally via a server.

The generally fixed second location is optionally a dock, optionally comprising a server.

The transport unit may further comprise a data store and a physical interface to allow for external computing devices to communicate with the data store; wherein the transport unit is arranged to transfer data between the first location and second location.

The transport unit may further comprise one or more sensors for capturing data related to surrounding objects, wherein captured data may be used by the processor for navigating the cart through the growing environment; optionally using computer vision. The transport unit may further comprise one or more odometers, wherein data received from said odometers may be used by the processor for navigating the cart through the growing environment

The transport unit may further comprise means for weighing and sorting the crops and/or means for inspecting harvested crops, optionally for readiness for harvest.

The transport unit may be configured to operate in accordance with a predetermined schedule. The transport unit may further comprise a GPS receiver; optionally wherein the transport unit is arranged to transmit an indication of location to a server. The transport unit may further comprise one or more light sources and/or a battery for powering the transport unit.

According to at least one aspect described herein, there is provided a maintenance unit for use with one or more autonomous units for operating on crops in a growing environment, comprising: a powered cart; one or more robotic arms mounted on the cart, each arm having an end-effector for use in operating on one or more autonomous units; and a processor for controlling movement of the cart and movement of the one or more robotic arms; wherein the maintenance unit is arranged to perform maintenance operations on the one or more autonomous units.

Optionally, the maintenance operations comprise one or more of: unscrewing/rescrewing panels; changing a component; charging a battery; re-wiring; changing a tyre/wheel; mending a puncture; cleaning (for example, cleaning a camera); and removing blockages.

The maintenance unit may further comprise one or more sensors for capturing data related to surrounding objects, wherein captured data may be used by the processor for navigating the cart through the growing environment; optionally using computer vision. Captured data may be further used by the processor to identify units requiring maintenance, optionally using a trained model.

The maintenance unit may further comprise one or more odometers, wherein data received from said odometers is used by the processor for navigating the cart through the growing environment. The maintenance unit may further comprise a GPS receiver; optionally wherein the maintenance unit is arranged to transmit an indication of location to a server. The maintenance unit may further comprise one or more light sources.

The maintenance unit is optionally capable of maintaining itself.

According to at least one aspect described herein, there is provided a dock for one or more autonomous units; wherein the one or more autonomous units comprise one or more of: an operating unit as described herein; a mapping unit as described herein; a transport unit as described herein; and a maintenance unit as described herein.

Optionally, the dock is arranged to store the autonomous units when not in use. The dock may be arranged to receive harvested crops from the one or more autonomous units. The dock may be arranged to supply power to the one or more autonomous units.

According to at least one aspect described herein, there is provided a growing environment, comprising a plurality of rows of frames for growing plants; and a plurality of navigation aids to assist autonomous units with navigation through the plurality of rows.

Optionally, the plurality of navigation aids comprise any or all of: position markers; guide wires; colour coded areas; magnetic strips; backdrops for crops; and visible tags/barcodes applied to obstacles and/or plants.

The growing environment may further comprise one or more cameras for monitoring the growing environment and/or means for conveying objects out of the growing environment. The growing environment may further comprise a plurality of wired network access points for the autonomous units; the network access points being spread throughout the growing environment.

The plurality of rows of frames may be movable relative to each other thereby to allow adjustment of the width of the interstitial spaces between rows and/or adjustment of the vertical position of each row.

According to at least one aspect described herein, there is provided a growing environment comprising a plurality of rows of frames for growing plants, wherein the plurality of rows of frames are movable relative to each other thereby to allow adjustment of the vertical position of each row and the width of the interstitial spaces between rows. The growing environment may be a greenhouse.

According to at least one aspect described herein, there is provided a system for harvesting crops in a target area, comprising: one or more operating units for harvesting crops in a target area; a dock for receiving harvested crops; and one or more transport units for transporting harvested crops from the one or more operating units to the dock.

The one or more transport units may be configured to navigate to a transmitted location of the one or more operating units. Optionally, the one or more operating units comprise one or more operating units as described herein, the one or more transport units comprise one or more transport units as described herein, and/or the dock comprises a dock as described herein.

According to at least one aspect described herein, there is provided a system for operating on crops in a target area, comprising: one or more operating units for operating on crops; one or more mapping units capturing data related to crops in a target area; a processor for mapping locations of the crops in the target area using the captured sensor data; generating one or more routes between at least some of the crops in the target area based on the mapped locations; and for routing the one or more operating units along the one or more routes thereby to operate on at least one of the crops on the one or more routes.

Optionally, the one or more operating units comprise one or more operating units as described herein and/or the one or more mapping units comprise one or more mapping units as described herein.

The system may further comprise a dock for receiving harvested crops, optionally wherein the processor is located in the dock. The dock may comprise a dock as described herein.

The system may further comprise one or more transport units for transporting harvested crops from the one or more operating units to the dock. The one or more transport units may comprise one or more transport units as described herein. The one or more transport units are optionally arranged to communicate data between the units and the dock via physical data connections.

The system may further comprise one or more maintenance units for maintaining the one or more operating units; the one or more mapping units; and/or the one or more transport units. The one or more maintenance units may comprise one or more maintenance units as described herein.

The system may further comprise communication means provided in communication with the processor; wherein each of the units comprise communication means for receiving data from the processor. All of the units may comprise comprise a mobile cart, such that the units are interchangeable and modular. The system may be configured to implement the method as described herein. The target area may be within a growing environment as described herein.

According to at least one aspect described herein, there is provided a method as described herein, wherein the one or more operating units may be one or more operating units as described herein and/or the one or more mapping units may be one or more mapping units as described herein. The target area may be within a growing environment as described herein.

According to at least one aspect described herein, there is provided an autonomous unit for use in a system for operating on crops comprising: a powered cart; a processor for controlling movement of the cart; one or more sensors mounted on the cart; and (optionally) one or more robotic arms mounted on the cart; wherein the unit is configured to travel through a growing environment, optionally based on data received form the one or more sensors, optionally to perform one or more predetermined tasks within the growing environment.

The invention extends to methods, system and apparatus substantially as herein described and/or as illustrated with reference to the accompanying figures.

The invention also provides a computer program or a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Any feature in one aspect of the invention may be applied to other aspects of the invention, in any appropriate combination. In particular, method aspects may be applied to apparatus aspects, and vice versa. As used herein, means plus function features may be expressed alternatively in terms of their corresponding structure, such as a suitably programmed processor and associated memory.

Furthermore, features implemented in hardware may generally be implemented in software, and vice versa. Any reference to software and hardware features herein should be construed accordingly.

As used herein, the term ‘crop’ preferably connotes any cultivated plant (or part of a cultivated plant), more preferably part of a cultivated plant which is removed and gathered for human, animal, and/or industrial use.

As used herein, the term ‘supporting part’ preferably connotes to a part of a plant where crops develop and/or a part of a plant which supports crops. For crops such as tomatoes, the supporting part may be referred to as a ‘truss’.

As used herein, the term ‘harvesting’ preferably connotes the process of collecting (i.e. gathering) at least part of a crop from a particular location; more preferably the process of both extracting and collecting (i.e. removing and gathering) at least part of a crop. The term ‘harvest’ preferably should be understood as falling within the scope of the term ‘operate on’, which refers to a variety of possible processing operations (of which harvesting is one).

As used herein, the term ‘route’ preferably connotes a route between locations (preferably, the locations of crops) in three-dimensional space (i.e. not merely a particular course along which a mobile unit moves).

As used herein, the term ‘growing environment’ preferably connotes any controlled environment for growing crops; more preferably a controlled environment in which crops are grown generally in rows or other predefined formations; yet more preferably a greenhouse. As used herein, the terms ‘growing environment’ and ‘greenhouse’ are interchangeable.

As used herein, the term ‘pipe-rail system’ preferably connotes a heating system for greenhouses (or other growing environments) in which heated pipes are arranged close to a floor of the greenhouse in rows, where plants are arranged in rows above the rows of heated pipes.

As used herein, the term ‘cart’ preferably connotes any powered or unpowered vehicle, in particular a squat vehicle; more preferably a squat vehicle having suitable dimensions to travel between rows of plants in a growing environment including a pipe-rail system. As used herein, the terms ‘cart’, ‘trolley’, and ‘pipe-rail trolley’ are interchangeable.

As used herein, the term ‘unit’ preferably connotes an autonomous robot; more preferably an autonomous robot that is generally interchangeable with other robots arranged to perform different functions; yet more preferably an autonomous robot formed generally with a cart-like chassis. As used herein, all references to a ‘unit’ in the singular preferably also connote the plural, and vice versa. As will be explained, the various types of units described have many components in common, and may be configured or adapted to perform the functions of other types of units. As such, all of the features described with reference to one type of unit may equally be applied to another type of unit.

As used herein, the term ‘central system’ or ‘central processor’ preferably connotes any kind of processor or device for controlling units of a system; more preferably a processor located in a dock of a system.

As used herein, all references to a ‘camera’ or a ‘sensor’ in the singular preferably also connote the plural, and vice versa.

As used herein, the term ‘manipulation device’ preferably connotes any actuable device capable of manipulating and/or operating on crops; more preferably a robotic arm.

As used herein, the term ‘end effector’ preferably connotes a device at the distal end of a robotic arm or other manipulation device; more preferably a device configured to perform particular actions on crops (such as grasping).

As used herein, the term ‘harvestability’ preferably connotes a measure of one or more features of the crop, which may be used to determine whether the crop is ready to be harvested.

It should also be appreciated that particular combinations of the various features described and defined in any aspects of the invention can be implemented and/or supplied and/or used independently.

The invention will now be described, purely by way of example, with reference to the accompanying drawings, in which:

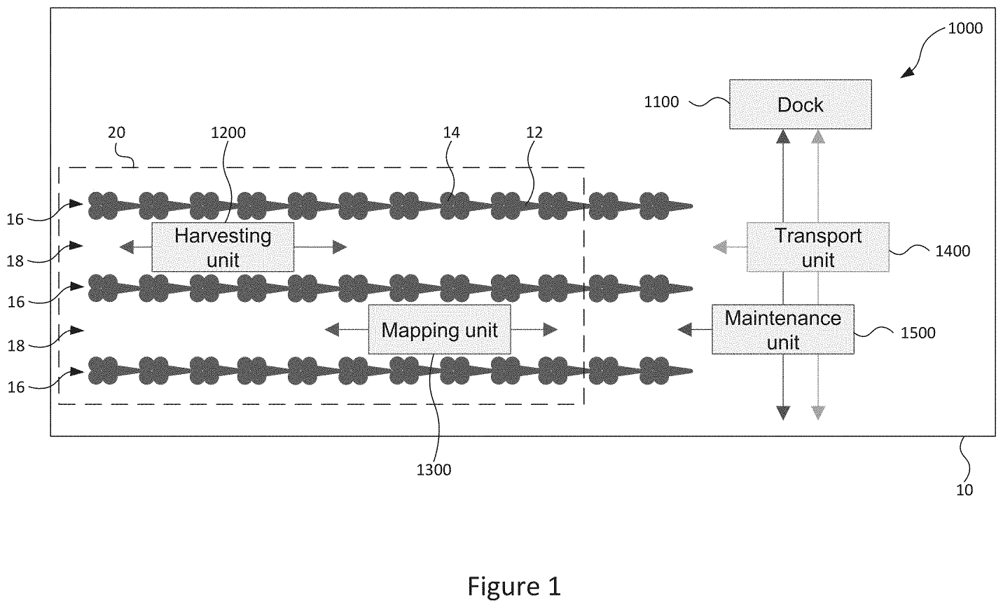

FIG. 1 shows a schematic diagram of a system for operating on crops in a growing environment such as a greenhouse;

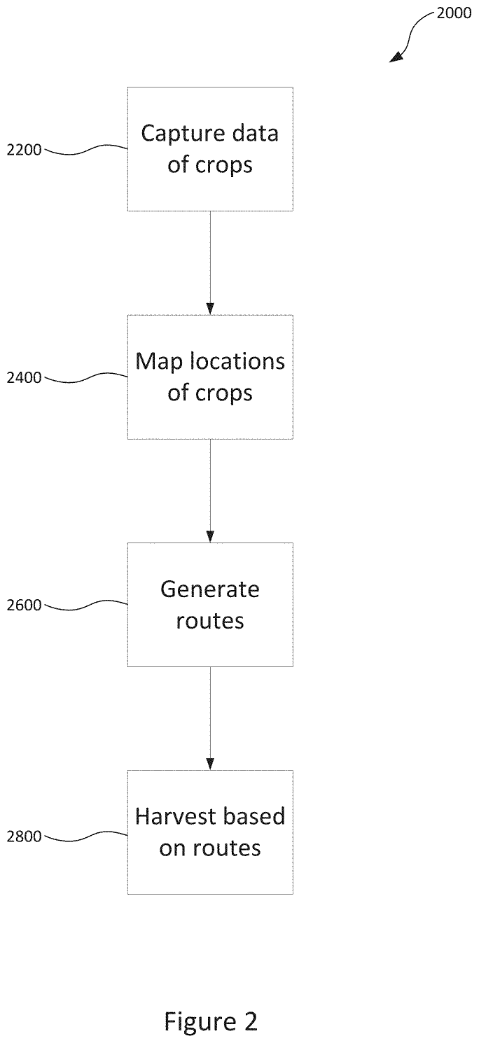

FIG. 2 shows a flow diagram outlining a method of operating on crops in a target area;

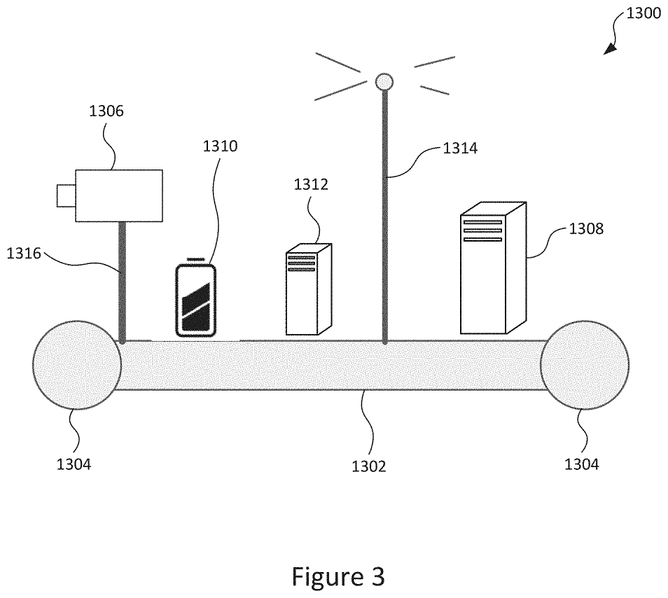

FIG. 3 shows a schematic diagram of a mapping unit;

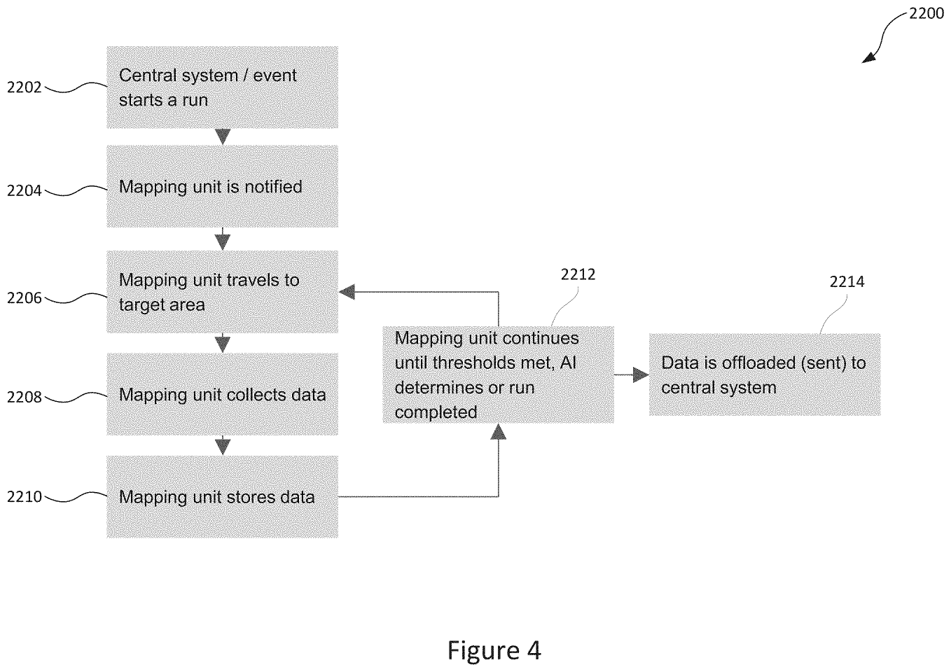

FIG. 4 shows a flow diagram illustrating a method of operating the mapping unit;

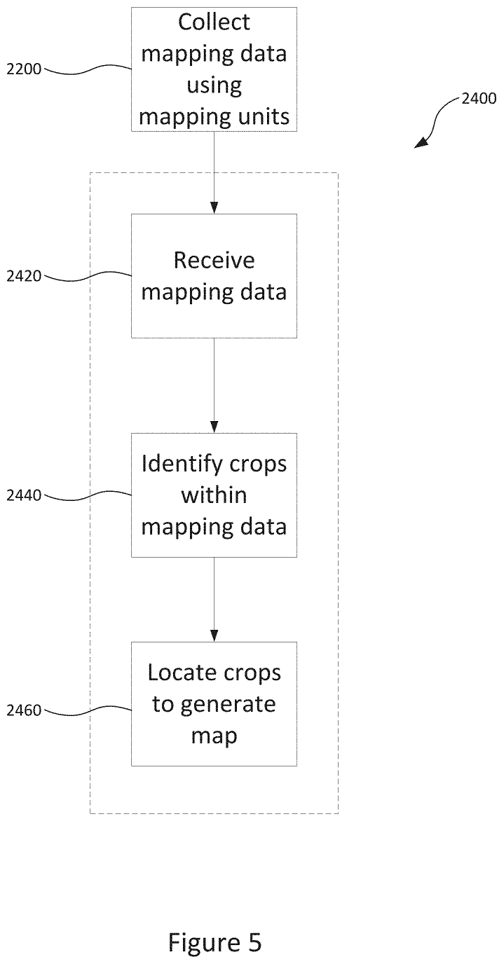

FIG. 5 shows a flow diagram illustrating a method of mapping the location of crops;

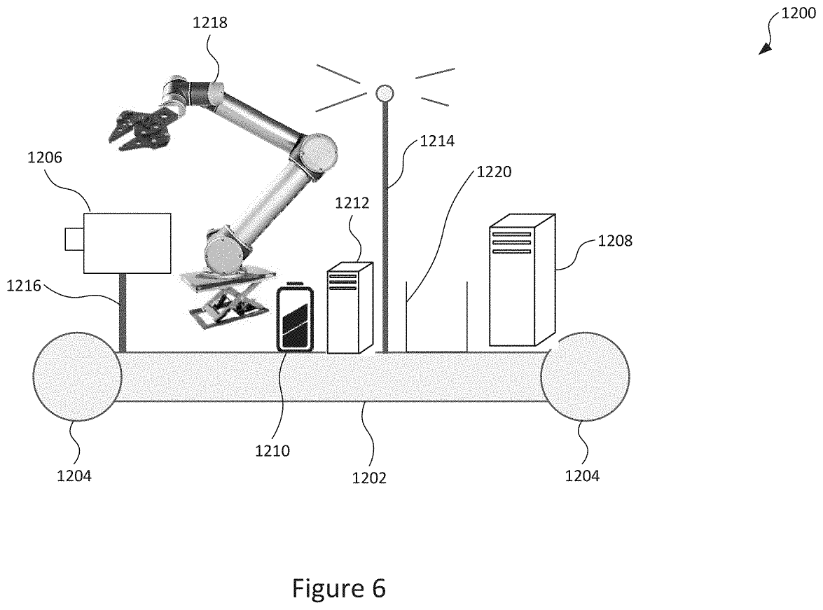

FIG. 6 shows a schematic diagram of an operating unit;

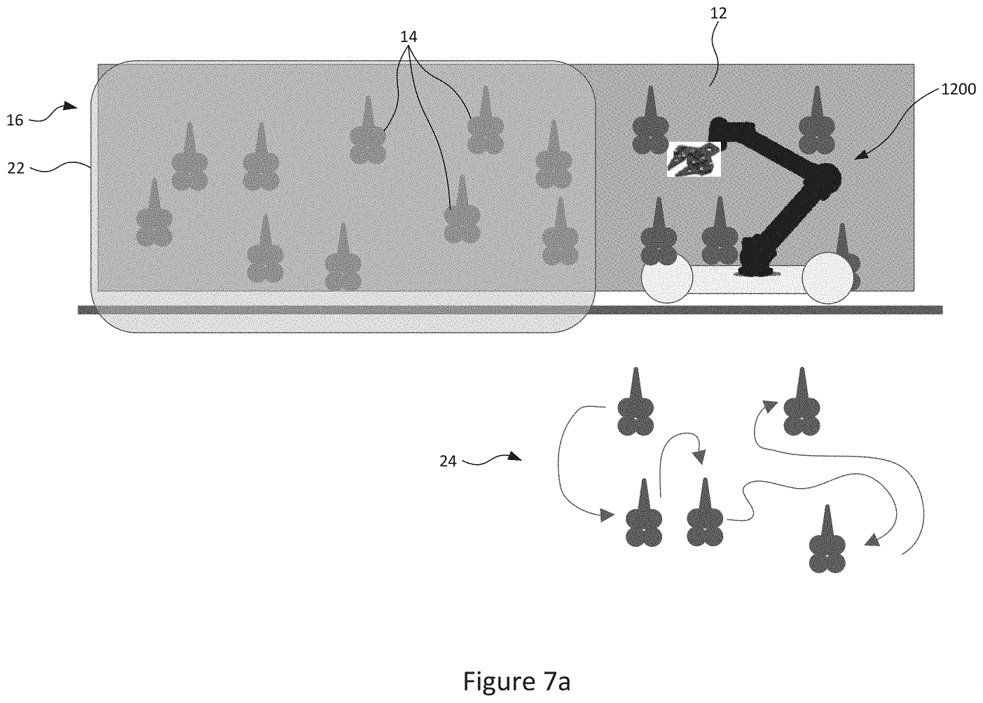

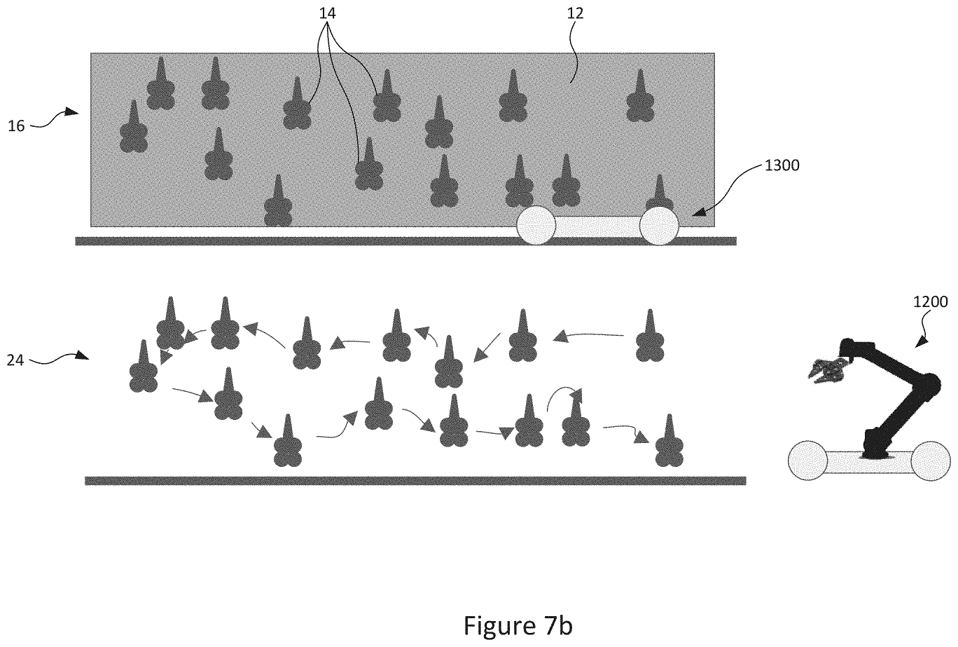

FIG. 7a shows exemplary operation of the operating unit without use of routes generated from the mapping data;

FIG. 7b shows exemplary operation of the operating unit with use of routes generated from the mapping data;

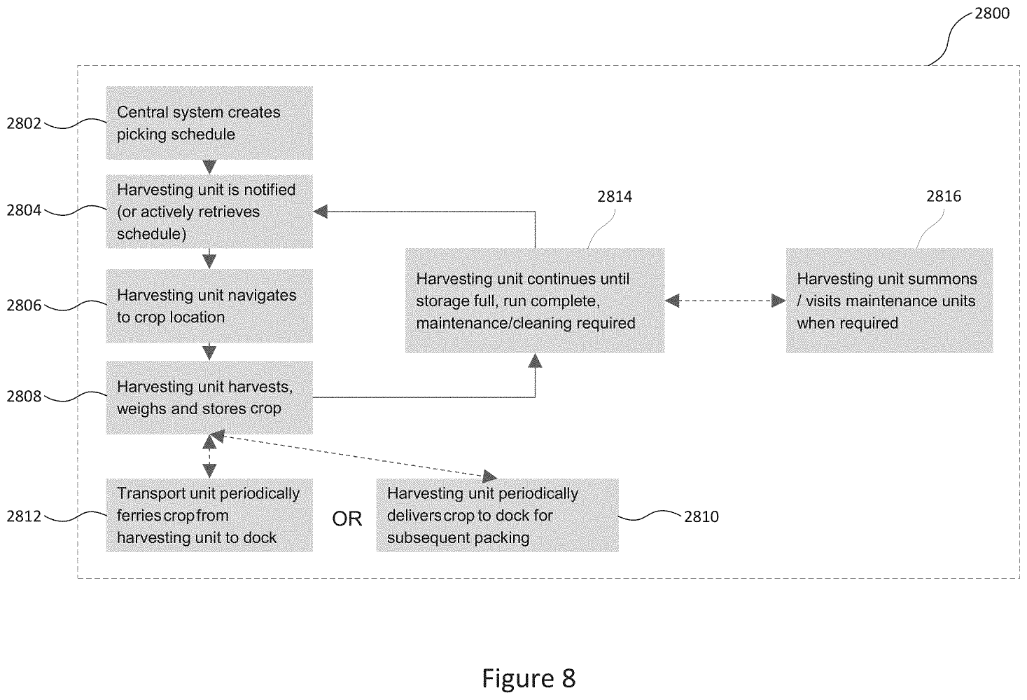

FIG. 8 shows a flow diagram illustrating a method of operating the operating unit;

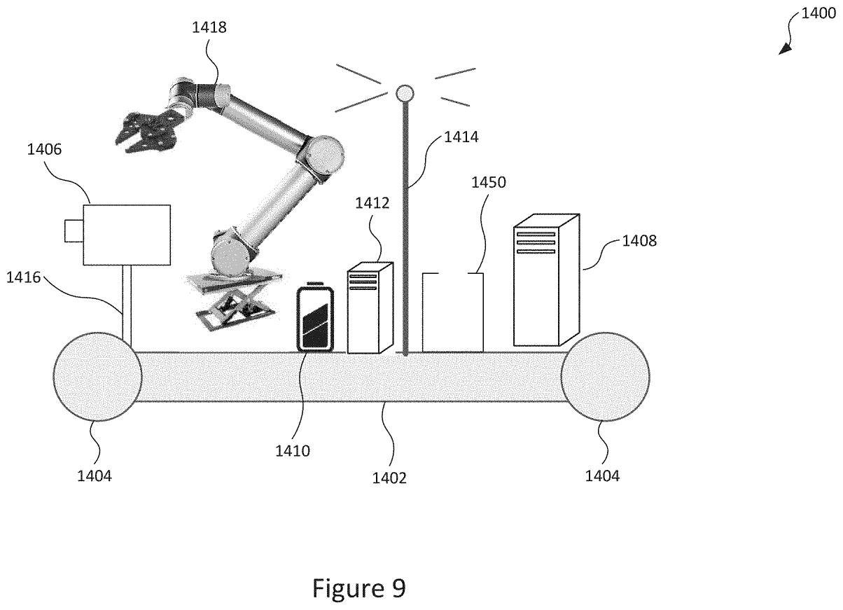

FIG. 9 shows a schematic diagram of a transport unit;

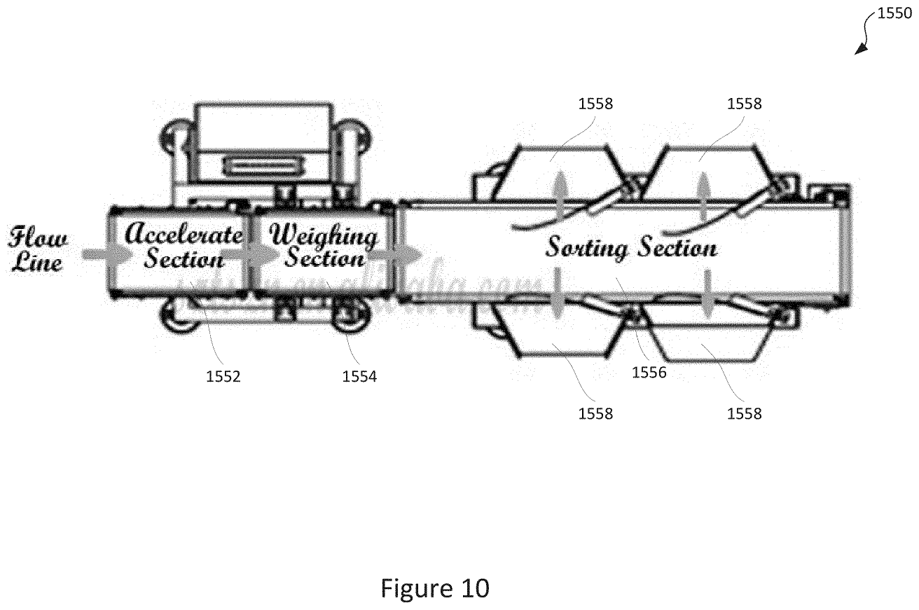

FIG. 10 shows a schematic diagram of a weighing/sorting apparatus of the transport unit in detail;

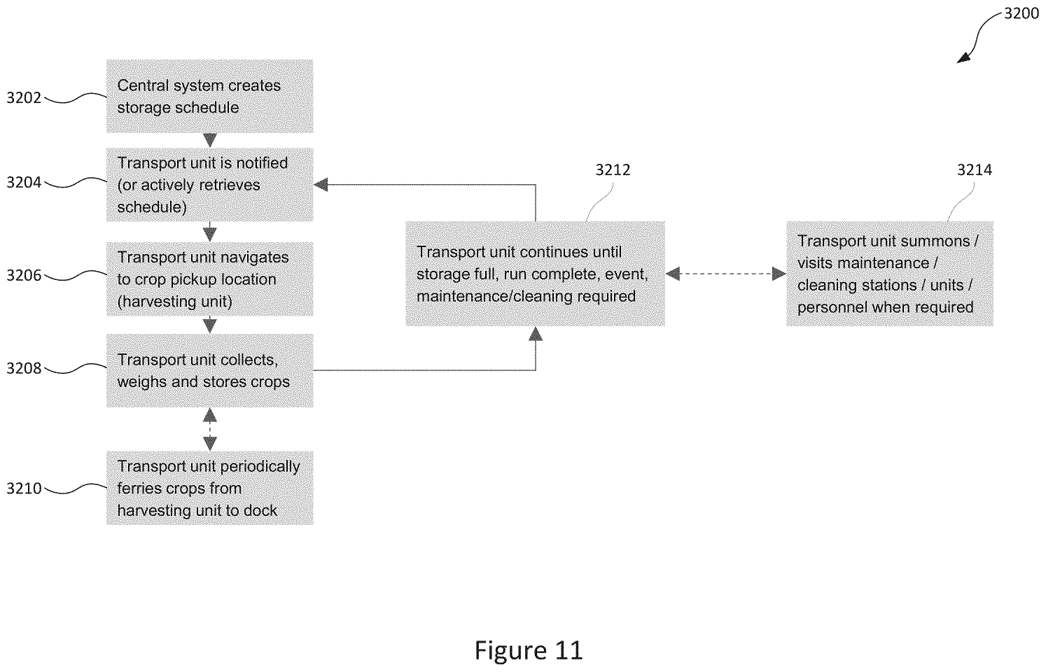

FIG. 11 shows a flow diagram illustrating a method of operating the transport unit;

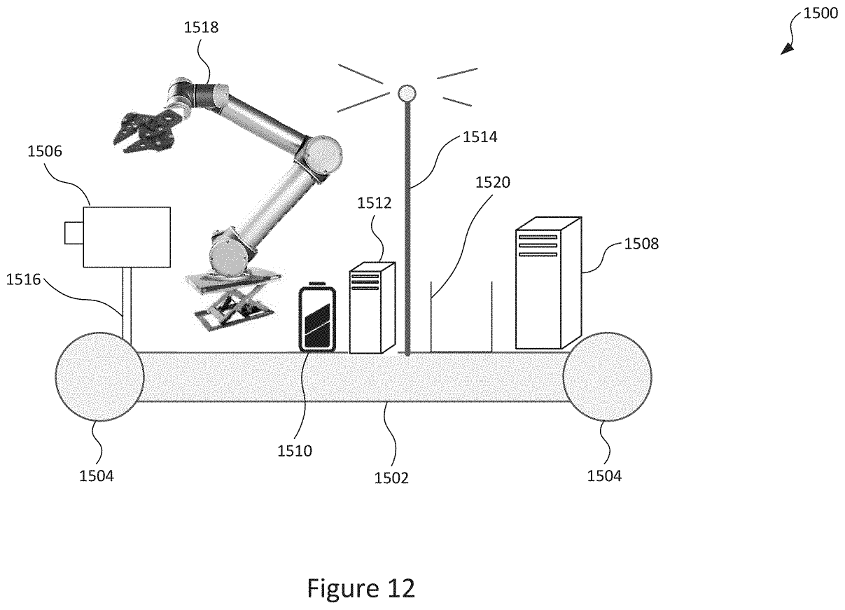

FIG. 12 shows a schematic diagram of a maintenance unit;

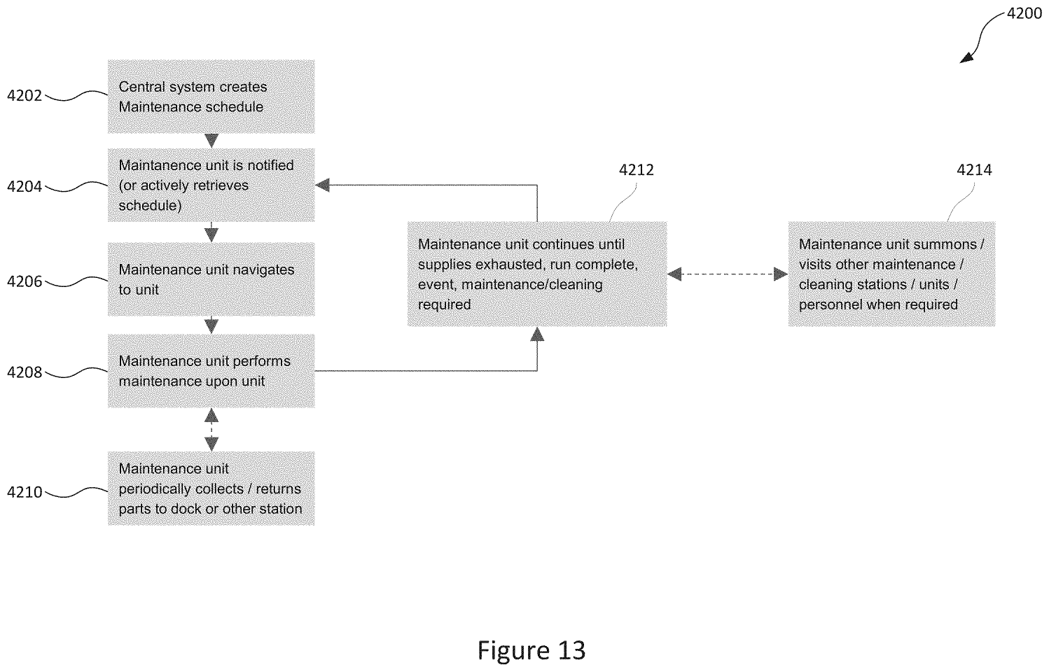

FIG. 13 shows a flow diagram illustrating a method of operating the maintenance unit;

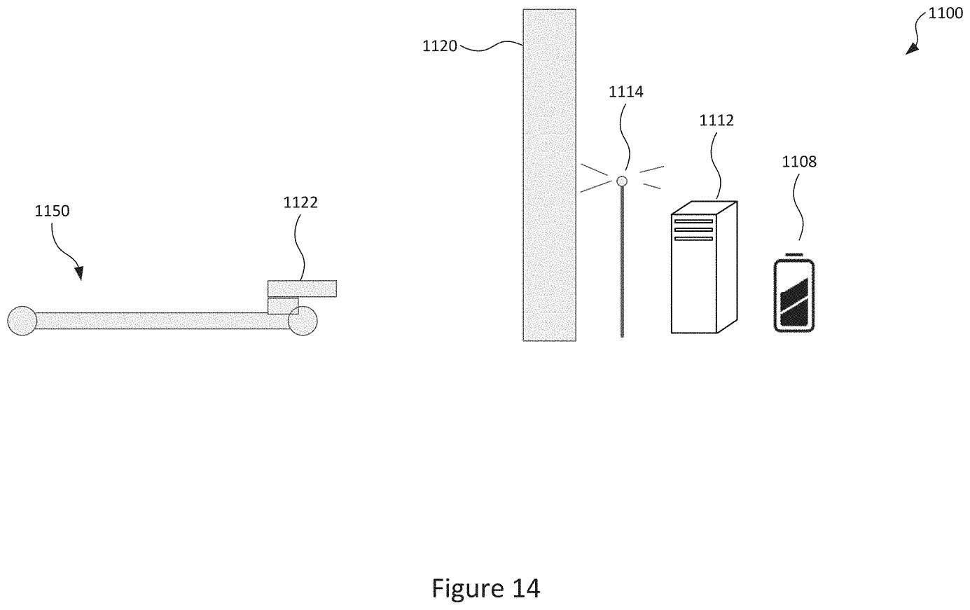

FIG. 14 shows a schematic diagram of a dock;

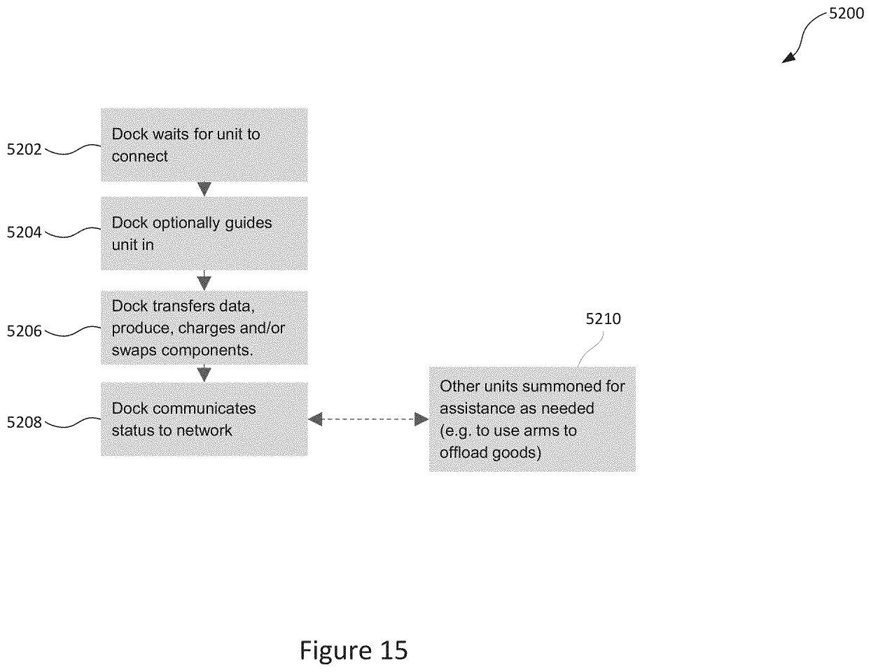

FIG. 15 shows a flow diagram illustrating a method of operating the dock;

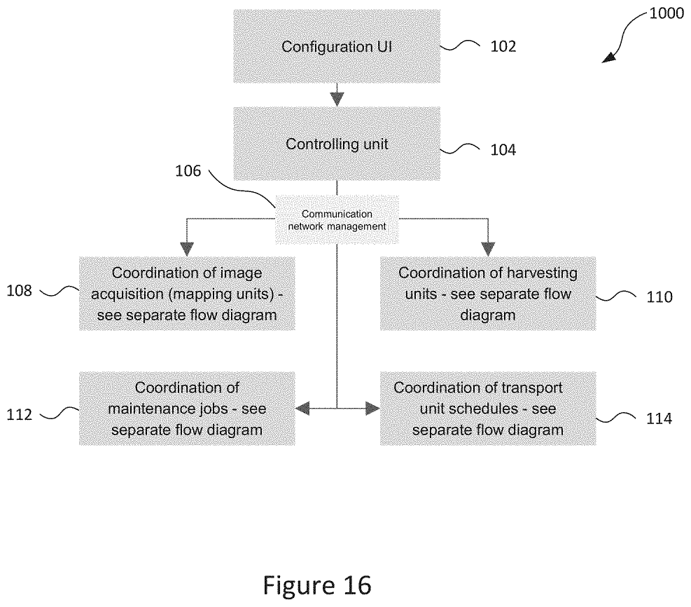

FIG. 16 shows a hierarchical dependency diagram illustrating connections between components of the system; and

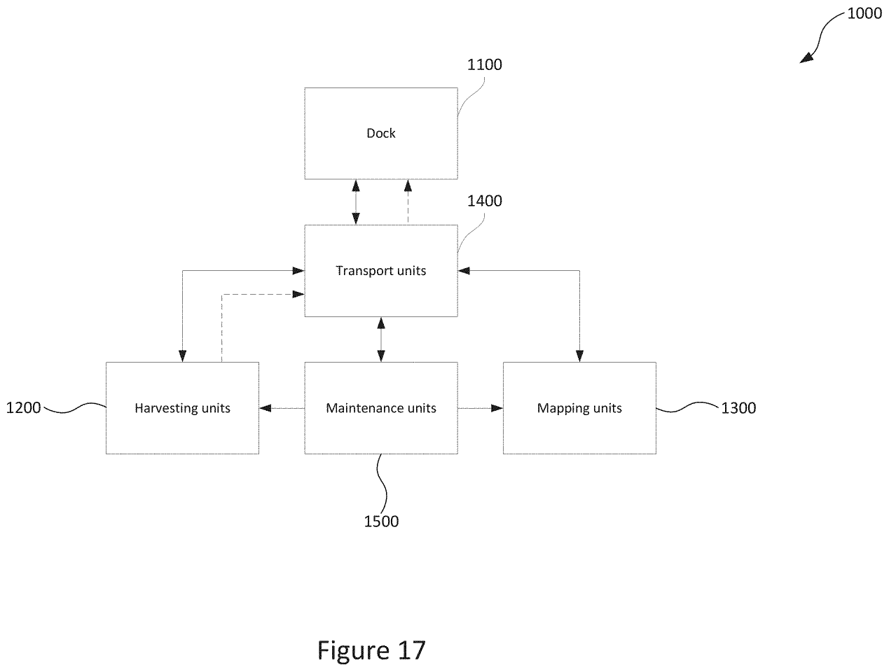

FIG. 17 shows a component diagram of a system for operating on crops in which transport units are used to transfer data.

### SPECIFIC DESCRIPTION

FIG. 1 shows a schematic diagram of a system 1000 for operating on crops in a growing environment such as a greenhouse 10.

In the greenhouse 10, plants 12 including crops 14 are grown on frames arranged in rows 16. This is a typical arrangement for many greenhouses, as it allows for high quality growth of many crops and allows for good access to the crops via interstitial rows 18. The rows 16 of plants 12 overlie rows of heated pipes (not shown) in what is known as a ‘pipe-rail system’.

Typically, crops 14 are harvested (or otherwise operated on) by human operators standing on or walking alongside ‘pipe-rail trolleys’, which are squat carts or vehicles which are arranged to travel along the interstitial rows 18 (either under their own power, or by being pushed by the operators) to allow the operators to pick the crops 14 by hand as the trolleys move past the rows 16.

In contrast, the system 1000 comprises a plurality of autonomous powered units forming a complete system for operating on and harvesting crops 14 within a target area 20 of the greenhouse 10, where the autonomous units are formed generally as ‘pipe-rail trolleys’ (i.e. they all have dimensions suitable for use in the interstitial rows 18). A plurality of categories of autonomous unit is provided, where each category of autonomous unit has different components and is arranged to perform a discrete task in the system 1000.

Each autonomous unit is arranged to traverse along the interstitial rows 18 to perform its discrete task. When not in use, the units are arranged to return to a dock 1100 for storing the units. The dock 1100 comprises a central processor (not shown) for controlling the autonomous units. Where the units are only temporarily not in use, they may alternatively sit idle in any area of the greenhouse away from the plants 12 (i.e. outside the interstitial rows 18).

In more detail, the autonomous units comprise operating units 1200 for operating on crops 14 (in particular, for harvesting crops), mapping units 1300 for capturing visual data of crops (which, as will be detailed later on, is used in generating a map of the location of crops), transport units 1400 for transporting harvested crops, and maintenance units 1500 for maintaining and repairing the other units. The use of a system 1000 of autonomous units having discrete tasks allows for an advantageous method of operating on crops to be performed.

FIG. 2 shows a flow diagram outlining a method 2000 of operating on crops in a target area, using the system 100.

In a first step 2200, data related to all of the crops within the predetermined target area is collected using one or more mapping units 1300. In a second step 2400, the locations of all of the crops 14 are mapped. In a third step 2600, the map data is used to generate one or more routes between at least some of the crops in the target area. In a fourth step 2800, one or more of the operating units 1200 are routed along the one or more routes, thereby to operate on at least one of the crops on the one or more routes. The details of each step in the method will be described in more detail later on with reference to the various autonomous units involved.

Mapping Unit

FIG. 3 shows a schematic diagram of a mapping unit 1300 according to the present invention.

The mapping unit 1300 comprises a ‘pipe-rail trolley’ 1302 (i.e. a squat cart) having wheels 1304. The pipe-rail trolley 1302 is powered, such that can move through the target area without human intervention. Other components of the mapping unit are mounted the trolley—in particular, such other components comprise a camera 1306, a processor 1308, a battery 1310, a motion controller 1312, and an antenna 1314.

One or more of the wheels 1304 are powered by motors (not shown) controlled by the motion controller 1312 to allow the mapping unit 1300 to move. Some or all of the wheels are arranged to turn (under the control of the motion controller) in order to allow the mapping unit to change direction—this may be achieved using one or more of a variety of known mechanisms, such as a rack and pinion mechanism operated by a rotary actuator. The motion controller is provided in communication with and is controlled by the processor 1308, which in turn is provided in communication with the antenna 1314. The processor receives instructions from an external processor (such as the central processor in the dock 1100) via the antenna 1314, and controls the mapping unit accordingly. The processor in the mapping unit includes a data store for storing instructions and visual data captured via the camera 1306. The battery 1310 is used to power the various components of the mapping unit.

The antenna 1314 allows the processor 1308 to communicate with the central processor (via a corresponding antenna) via a wireless network. The wireless network may use one of a variety of protocols, such as Wi-Fi ®, Bluetooth ®, or any kind of local area network.

The camera 1306 is a video camera, which is mounted on a movable platform or extension 1316 on the trolley 1302. The camera is arranged to capture visual data of substantially all of a particular target area 20 which the mapping unit 1300 is instructed to map—as such, the mapping unit is arranged to travel through and/or around the target area by travelling along each of the interstitial rows 18 in the target area in order to acquire the necessary visual data.

The mapping unit 1300 is configured to travel along the interstitial rows 18 (and move between the interstitial rows) based on visual data from the camera 1306, which is used as an input to known computer vision techniques (implemented by the processor 1308) such that the mapping unit has a model of the environment surrounding the mapping unit. Instructions (which may relate to a predetermined route) provided by an external processor and received via the antenna 1314 are then used to determine how the wheels 1304 should be moved—in an example, such instructions may be to the effect of ‘move down row 1, turn around, and move up row 2’. As will be described later on, the greenhouse 10 comprises visual aids to assist the mapping unit in recognising which row is which. Optionally, one or separate cameras for navigation are provided on the mapping unit in addition to the camera 1306 for capturing visual data for use in mapping.

The mapping unit 1300 may also be arranged to navigate on the additional basis of a predetermined plan of the greenhouse 10 (or at least the target area 20), where the processor 1308 determines the location of the mapping unit with reference to the plan by using a GPS signal (where the processor 1308 further comprises a GPS receiver) and/or by detecting particular items (such as a particular visual aids) in the visual data which have a known location with respect to the plan.

In order to acquire visual data, the mapping unit 1300 may be arranged to travel along each of the interstitial rows 18 several times and in several directions, in order to improve the reliability of the data and to allow the camera to capture visual data from various angles. In order to capture visual data of both rows 16 of plants adjacent a particular interstitial row 18, the camera may be configured to move, for example by using a mount on the extension 1316, or by using the extension itself. The camera itself may be a PTZ camera (i.e. the camera may be capable of performing ‘pan, tilt, [and] zoom’ operations) which moves as the mapping unit is moved. The camera may either continuously move as the mapping unit is moved, or alternatively may be repositioned at the end of each interstitial row. Alternatively the camera may be a plurality of cameras, such that visual data can be received from various sides of the mapping unit at once—for example, the mapping unit may comprise a plurality of cameras arranged in a generally spherical, hemi-spherical, or ring-like array. The camera may also incorporate a corresponding ‘time-of flight’ camera capable of using pulsed light to measure the distance of objects from the camera, or any other camera suitable for range imaging. The use of a conventional visual camera and a ‘time of flight’ camera allows for corresponding RGB video and ranging data to be collected (this combined dataset may be referred to as ‘RGBd’.)

FIG. 4 shows a flow diagram illustrating a method 2200 of operating the mapping unit 1300—this method is also the first step 2200 of the method 2000 of operating on crops in a target area.

In a first step 2202, a mapping ‘run’ is started (i.e. the mapping unit begins to map a particular target area). The central processor may issue a command (optionally in accordance with a schedule) in order to start the run. Alternatively, a particular event may cause the run to be started. For example, the mapping unit 1300 may be manually reset, or the mapping unit 1300 may be configured to operate at a particular time (in accordance with a pre-determined schedule).

In a second step 2204, the mapping unit 1300 receives notification that it should begin operation—for example, the mapping unit may receive a communication from the central processor via the antenna 1314. Such a communication comprises details of the mapping run, including the area 20 which is to be mapped, and the accuracy required. The details may also include a plan of the movements required to ensure that visual data related to the whole target area is captured.

In a third step 2206, the mapping unit 1300 travels to the target area 20 from a starting position, using the previously described components for navigating and moving. The starting position may be at the dock 1100, or alternatively at an idle position outside of the interstitial rows 18.

In a fourth step 2208, the mapping unit 1300 moves through the target area 20 (more specifically, the mapping unit moves up and down the various interstitial rows 18 of the target area 20) while collecting data using the camera 1306. In a fifth step 2210 (which may occur contemporaneously with the fourth step 2208), the collected data is stored in the data store associated with the processor 1308.

In a sixth step 2212, the mapping unit 1300 continues to move through the target area and collect data until the target area 20 has been traversed and mapped (i.e. until visual data relating to all crops 14 in the target area has been received—this may be determined by reference to one or more predetermined plans or maps, such as a GPS map, a magnetic map, and a radio localised map of the area (and the mapping unit's location with reference to the plan), or by reference to the plan of required movements). Sensors on the mapping unit (in particular the camera 1306) that are used in navigation of the unit may also be used to determine when to cease movement through the target area, for example by determining when the same objects reappear in the captured visual data.

The mapping unit 1300 may also cease collecting data if a halting command is received from the central processor (for example if the central processor determines that enough data has been collected, or if the mapping run is cancelled), or if a particular threshold is exceeded (for example, if battery charge falls below a certain level, or if data storage is nearing capacity).

In a seventh step 2214, the collected data is transmitted from the mapping unit 1300 to the central processor using the wireless network and antenna 1314. The data may also be transmitted in parts, or continuously as mapping is occurring.

The mapping unit 1300 then ceases operation until further instructions are received. The mapping unit may return to the dock 1100 or may sit idle in any area away from the greenhouse plants 12.

As will be appreciated, several mapping units 1300 may be used to map the target area 20 (or indeed various different target areas), in particular where each mapping unit maps a portion of the target area so as to increase overall mapping speed. As mentioned, the mapping unit 1300 may operate in accordance with a schedule, which may be arranged to re-map the target are at regular intervals so as to account for any changes in the location or size of crops as they grow, and/or to account for any crops which may have since been harvested.

Mapping Crops

FIG. 5 shows a flow diagram illustrating a method 2200 of mapping the location of crops, which is also the second step 2400 of the method 2000 of operating on crops in a target area.

A first step 2200 corresponds to the previously described method 2200 of operating the mapping unit 1300. In a second step 2420, the mapping data from the mapping unit 1300 is received at the central processor. The mapping data may optionally be further transmitted onto an external cloud server for processing, or alternatively may be processed on the central processor. In a third step 2440, crops 14 are identified within the mapping data, for example by use of a trained image recognition classifier built on machine learning principles.

In a fourth step 2460, a map of crops 14 in the target area 20 is generated by locating the identified crops, for example with reference to a predetermined plan of the target area (which may be the same plan that the mapping unit uses for navigation). The pre-determined plan of the target area is already known, and may be input by a user prior to the mapping units 1300 being used to capture visual data. Locating the crops may comprise determining a location associated with a particular identified crop in the visual data, for example by using visual aids located in or along each interstitial row 18.

In an alternative, the map of crops 14 in the target area 20 is generated by locating the crops relative to the mapping unit 1300 itself, more specifically the mapping unit's location at a particular time (the mapping unit can locate itself using the GPS receiver). This allows crops to be mapped without the use of a predetermined plan of the target area. In one example, the map of crops is generated based on a plan of the target area that is inferred from the visual data (for example, based on the time(s) that a particular crop appears and/or disappears in the captured data and/or based on detected visual aids) and the mapping unit's location at a particular time. In another example, the map is defined in relation to the mapping unit's location at a particular time (i.e. the map is formed from the relative (rather than absolute) locations of crops).

By identifying the location of each identified crop in relation to the plan of the target area, a map of the crops 14 in the target area is generated, for example by using regression techniques based on multispectral analysis of the input visual data, optionally coupled with RGBd or 3D point cloud data. The map is a 3D map (i.e. it includes the heights of the crops above the ground, their positions along the row, and their ‘depth’ in the plant (i.e. distance from a particular point in the interstitial row, such as the centre), but may alternatively be a 2D map (i.e. a map including only the crops' location in relation to a plan view of the target area, or simply the height of the crops and position along the row). A separate map may be created for each row, or alternatively an overall map (comprising multiple rows) may be created, optionally including an identifier (such as a number) for each row. The map of crops is used to generate route(s) 2600 for an operating unit(s) 1200, as will be described later on. The map of crops is generally stored as a 3D point cloud, but may alternatively be stored in different formats, such as feature points, vector representations, or mesh representations.

The method 2400 of mapping the location of crops may of course equally be applied to mapping the locations of other objects associated with the growing environment. The locations of further objects may be mapped at intervals and compared and/or integrated into the map of crop locations to allow for improved routes to be generated. Examples of such further objects include parts of plants (i.e. branches, leaves, and roots), parts of the growing environment, or miscellaneous objects such as trays, containers, or immobile units (such as the mapping unit 1300).

Operating Unit

FIG. 6 shows a schematic diagram of an operating unit 1200 according to the present invention. Like reference numerals are used to indicate components that are also present on the mapping unit 1300.

Similar to the mapping unit 1300, the operating unit 1200 comprises a ‘pipe-rail’ trolley 1202 having wheels 1204. Other components of the operating unit are mounted on the trolley—in particular, such other components comprise a camera 1206, a processor 1208, a battery 1210, a motion controller 1212, an antenna 1214, an operator 1218, and a storage space 1220 (such as a container) for harvested items.

Any components of the operating unit 1200 which can also be found upon the mapping unit 1300 operate in the same way, so that the movement of the operating unit 1200 uses the same mechanisms as that of the mapping unit 1300. Similarly the camera 1206 works in a similar way to the camera 1306 on the mapping unit 1300, although the camera 1206 on the operating unit 1200 is not principally used for mapping the locations of crops 14.

The operator 1218 is a manipulation device such as an actuable robotic arm, which may be optionally mounted on a moveable platform. The end effector of the arm comprises means to grip a crop, separate the crop and/or the truss supporting the crop from the plant, and move the cut truss and/or crop to the storage space 1220—this entire process may be described as ‘harvesting’ a crop. The operator may optionally also be able to perform various other operations on crops or surrounding objects, as will be detailed later on.

The operator does not attempt to reproduce full human arm movement (i.e. it cannot ‘reach around’ objects), as this is generally slow, computationally challenging, and unreliable. As such, the operator 1218 is an arm which is able to position the end effector with less than six degrees of freedom—in particular, the arm may be a ‘cylindrical’ arm, which has two linear axes of movement and one circular axis (where the circular axis is generally a vertical axis), or another arm which can position the end effector with three axes of movement. In an alternative, the operator is a Cartesian arm (also known as a ‘Cartesian coordinate robotic arm’ or a ‘linear robotic arm’), which has three linear axes of motion which are at right angles to each other. The use of a relatively simple arm decreases computation time in harvesting, as well as reducing maintenance.

The camera 1206 is used for navigation (as described with reference to the mapping unit) and also for fine positioning of the operator 1218, using the previously described computer vision processing. The camera 1206 may also be used to determine the readiness for harvest (or ripeness) of crops, as will be described later. Optionally, a further camera (or a non-visual sensor) is located on or proximate the operator 1218 to capture more detailed information related to crops and from a position nearer the end effector. Data from the further camera may be used in fine positioning of the end effector and/or in determining the readiness for harvest of crops, either as the sole input or as a further input.

Generating Routes

In the third step 2600 of the method 2000, in which routes for the operating unit 1200 are generated, the map of the crops 14 in the target area 20 is used as an input to a route-finding algorithm (implemented by the central processor and/or a cloud server) to generate an efficient route (i.e. time-efficient) for an operating unit 1300 (or a plurality of efficient routes for a plurality of operating units 1300) between the crops. The routes are routes in 3D, such that they relate to routes in 3D between crops (i.e. requiring both movement of the operating unit itself, which can only move along the floor of the growing environment, and movement of the operator 1218, which can vary in height and position). The routes may comprise an order in which the crops should be operated on (in which case the operating unit calculates the exact movements required), and/or may further comprise details of the exact movements required.

A variety of methods may be used to generate routes based on the map of crops 14, including visibility graphs (which connect visible vertices of polyhedrons), random-exploring algorithms (such as rapidly exploring random tree), probabilistic road maps, optimal search algorithms (such as Dijkstra's algorithm), following by example, and bioinspired algorithms. As will be appreciated, any of the above methods may be combined or adapted to improve their utility in generating routes.

The routes are further generated based on known properties of the operating unit 1200—such as a speed of movement (including computation time) of the operating unit itself, and a speed of movement (including computation time) of the operator 1218. Since movement speed and (in particular) computation time is generally slower for the operator than for the operating unit itself, the routes are generated based on these different speeds to minimise the total time of harvesting crops—this may result, for example, in routes in which crops are picked in generally horizontal or diagonal rows, so as to minimise movement of the operator (though some movement of the end effector is of course necessary in order to harvest crops). The known properties of the operating unit may be included in the route generating methods as weightings, for example.

A further known property on the basis of which routes may be generated is the geometry of the operator 1218—where a cylindrical arm is used, routes are generated in which the use of a cylindrical arm is non-limiting. Routes may also be generated based on the number of operating units 1300 available—a target area may be broken up/shared between a plurality of operating units so as to improve the overall speed of the harvesting process.

FIG. 7a shows exemplary operation of the operating unit 1300 without use of routes generated from the mapping data, shown from within an interstitial row 18 (facing toward a row 16 of plants 14). If the operating unit 1300 were to be used on its own (i.e. without a separate mapping run having been performed to determine the locations of crops), the operating unit 1300 would only be able to determine the locations of crops in view of the camera 1206—these will usually be only those crops in the immediate vicinity of the operating unit. As such, a region 22 of the row 16 is not visible to the operating unit (and to the system 100 more generally), so planned routes cannot reliably incorporate crops in this region.

A typical route 24 for harvesting (or performing other operations on crops), therefore, may be between only those crops 14 that are known to the operating unit 1200. The operating unit may then move so that at least part of the region 22 is visible to the camera, and then harvest according to a new route. The route 24 involves multiple movements of the operator, which is relatively slow. Furthermore, such a route may have a relatively high computation time due to the greater reliance on the operator.

FIG. 7b shows exemplary operation of the operating unit 1300 with use of routes generated from the mapping data, again shown from within an interstitial row 18 (facing toward a row 16 of plants 14). When a mapping unit 1300 is used to map the target area 20 (including a single row of crops, as shown), the location of all of the crops is known. This allows an improved path 24 to be determined, in which movement of the operator 1218 is minimised thereby to minimise the total time taken for harvesting (or performing other operations on crops).

As will be appreciated, using separate operating units 1200 and mapping units 1300 allows for operating units to be used for generally continuous harvesting, as there is no need for the operating units to break off to perform other tasks (e.g. mapping). Using separate operating units and mapping units may also save on componentry, as there is no need for mapping units to include an operator 1218.

Harvesting Crops

FIG. 8 shows a flow diagram illustrating a method 2800 of operating the operating unit 1300 for harvesting—this method is the fourth step 2800 of the method 2000 of harvesting crops 14 in a target area.

In a first step 2802, the central processor generates one or more routes (or ‘picking schedules’), as described, and allocates each route to a particular operating unit 1200.

In a second step 2804, the operating unit 1200 receives notification that it should begin operation—for example, the operating unit may receive a communication from the central processor via the antenna 1314, where the communication comprises details of the route.

In a third step 2806, the operating unit 1200 travels to the target area 20 from a starting position (and more particular to a location of a particular crop which is the first crop on the route), using the previously described components for navigating and moving. The starting position may be at the dock 1100, or alternatively at an idle position outside of the interstitial rows 18.

In a fourth step 2808, the operating unit 1200 moves through the target area 20 (more specifically, the operating unit moves up and down the various interstitial rows 18 of the target area 20) in accordance with the route.

At each crop, the operating unit is arranged to determine whether the crop should be picked using the camera 1206. The camera in turn includes each crop in its field of view, and may focus and/or zoom on each crop, so as to receive detailed visual data related to the crop. Using the processor 1208, the visual data is compared against a trained classifier (built on machine learning principles) which is configured to output an indication of the ripeness of the crop (or otherwise the readiness of the crop for harvesting, in particular for certain crops which are suitable to be harvested when not entirely ripe). The classifier may be arranged to classify crops based on the hue, saturation, and/or intensity of the crop (as it appears in the visual data) and/or based on historic data. The indication may be output as a score, which may be compared against a threshold. If the indication exceeds the threshold, the crop is harvested; otherwise, the operating unit disregards the crop and moves onto to the next crop along the route. The classifier may also or alternatively use the size of the crop as an input—for example, the operating unit 1200 may only harvest those crops above a certain pre-determined size.

In an alternative configuration (which may be more suited to certain varieties of crop 14), the operating unit 1200 simply harvests all crops 14 along its route. The crops may then be analysed and/or sorted at a later stage in processing.

If a crop 14 is determined as being ready to be harvested, the operator 1218 is used to locate the end effector in a position to operate on the crop. The mapping data as well as visual data from the camera 1206 is used to locate the end effector, where the visual data is used for fine positioning of the end effector so as to account for any movement of the crop 14 from the last mapped location. In one example, fine positioning is performed by capturing sufficient visual data of the crop so as to generate a three-dimensional model of the crop and its surroundings. The fine movements of the operator and end effector are then calculated on the basis of this three dimensional model. Once in position, the end effector harvests the crop by gripping the crop and/or truss, and then separates the crop and/or truss from the plant. The harvested crops/trusses are then placed into the storage space 1220 of the device.

In a fifth step 2810, the operating unit 1200 is arranged to periodically break off from the route to deliver the stored crops 14 and/or trusses to the dock 1100, where they are removed. The operating unit then resumes the route at the point it left off. In an alternative fifth step 2812, the transport unit 1400 navigates to the operating unit, loads the stored crops and/or trusses, and ferries the crops/trusses to the dock, where they are removed—this process will be described in more detail later on. This may allow the operating unit to continue harvesting (rather than transporting the crops/trusses to the dock), and so may improve the overall speed of the harvesting process.

In a sixth step 2814, the operating unit 1200 continues to move along the route and assess and/or harvest crops until the route is complete (i.e. all crops have been assessed and/or harvested—this may be determined by use of the same techniques as described with reference to determining when to cease operations of the mapping unit 1300, i.e. in the sixth step 2212 of the method 2200 of operating the mapping unit). The operating unit 1200 may also cease harvesting if a halting command is received from the central processor (for example if the central processor determines that enough crops have been harvested, or if the harvesting process is cancelled), or if a particular threshold is exceeded (for example, if battery charge falls below a certain level, or if the storage space 1220 is nearing capacity).

In an optional seventh step 2816, if maintenance of the operating unit 1200 is required (for example, if it is detected that battery level falls below a pre-determined threshold), the operating unit is arranged to travel to a predetermined location for maintenance, or alternatively to the maintenance unit 1500. The maintenance unit 1500 may also navigate to the operating unit 1200 to perform maintenance, which may minimise interruptions to the harvesting process.

Once the route is complete, the operating unit 1200 then ceases operation until further instructions are received. The operating unit may return to the dock 1100 or may sit idle in any area away from the interstitial rows 18.

Although the method 2800 has been generally described with reference to harvesting, it will be appreciated that it could equally be adapted for use with other processing operations, for example where the trained classifier is used to determine which of a plurality of processing operations are required for each crop.

Transport Unit

FIG. 9 shows a schematic diagram of a transport unit 1400 according to the present invention. Like reference numerals are used to indicate components that are also present on the mapping unit 1300 and/or the operating unit 1200.

Similarly to the operating unit 1200, the transport unit 1400 comprises a ‘pipe-rail’ trolley 1402 having wheels 1404. Other components of the operating unit are mounted on the trolley—in particular, such other components comprise a camera 1406, a processor 1408, a battery 1410, a motion controller 1412, an antenna 1414, a transfer mechanism 1418, and a weighing/sorting apparatus 1450 for receiving harvested items.

Any components of the transport unit 1400 which can also be found upon previously discussed units operate in the same way, so that, for example, the movement of the transport unit 1400 uses the same mechanisms as that of the mapping unit 1300.

Similarly to the operator 1218 of the operating unit 1200, the transfer mechanism 1418 is a manipulation device such as a robotic arm, which may optionally be mounted on a moving platform. Here, the end effector of the arm comprises means for gripping crops which have been harvested and for transferring them to the weighing/sorting apparatus 1418 (or alternatively a storage space)—an example of a suitable means may be a pair of jaws. The end effector also comprises means to grip and transfer components, such as spare parts, where this may be the same means or a separate means. More specifically, the transfer mechanism 1418 is a robotic arm which is able to position the end effector with less than six degrees of freedom, such as a ‘cylindrical’ or ‘Cartesian’ arm (as previously described).

FIG. 10 shows the weighing/sorting apparatus 1450 of the transport unit 1400 in detail. The weighing/sorting apparatus comprise an accelerating section 1552, a weighing section 1554, and a sorting section 1556, which crops 14 proceed through consecutively, for example by conveyor belt. The accelerating section 1602 receives crops and transfers them to the weighing section, which weighs them. Information about the weight of the crops 14 may be stored here to be used for packaging. The crops are then sorted in the sorting section, where there are multiple storage bins 1558 into which crops 14 pass depending on a sorting method. This may be used to sort crops by type or by size, so that they are packaged correctly.

FIG. 11 shows a flow diagram illustrating a method of operating the transport unit 1400. As mentioned above, the transport unit 1400 is arranged to travel (or ‘shuttle) between the operating unit 1200 (which is at a generally variable location) and the dock 1100 (which is at a generally fixed location) to transfer harvested crops from the operating unit to the dock 1100. As will be appreciated, the transport unit collecting crops from the operating unit may enable the operating unit to spend more time harvesting, as it need not spend time transferring crops to a storage area.

In a first step 3202, the central processor generates a schedule for use of one or more transport units 1400 (which may be optionally based on the mapping data and/or the generated routes)—in a simple case, a particular transport unit may be allocated to a particular operating unit 1200, and may continuously ferry between the operating unit and the dock 1100. In another example, a transport unit may be configured to collect crops from various transport units, and/or may lie idle for most of the time and only embark on a ‘run’ to the operating unit(s) and the dock at intervals. Such schedules are dynamically updated in response to events (for example, new schedules may be produced if an operating unit 1200 reaches the end of its route. The schedule may comprise precise movements required, or alternatively may only relate to a list of particular operating units—in which case the transport unit uses its own capabilities to navigate to the operating unit(s) and the dock.

In a second step 3204, the transport unit 1400 receives notification that it should begin operation—for example, the transport unit may receive a communication from the central processor via the antenna 1414, where the communication comprises details of the schedule.

In a third step 3206, the transport unit 1400 travels to an operating unit 1200 from a starting position, using the previously described components for navigating and moving. The starting position may be at the dock 1100, or alternatively at an idle position outside of the interstitial rows 18.

In a fourth step 3208, the transport unit 1400 collects crops 14 from the storage space of the operating unit 1200 and transfers them into the weighing/sorting apparatus 1450 using the transfer mechanism 1418. The crops are then weighed and sorted using the weighing/sorting apparatus, and rest in the storage bins 1558.

In a fifth step 3210, the crops stored on the transport unit 1400 are periodically transferred to a particular collection location—more specifically, the dock 1100. The transfer may take place when a weight or volume threshold of storage space upon the transport unit used is exceeded (suitable sensors may be connected to the weighing/sorting apparatus 1450 accordingly). Transfers may also take place at regular time periods or in dependence on harvesting events—for example, a transport unit may follow an operating unit 1300 until the operating unit completes a route before transferring the collected crops to the dock and navigating to another operating unit. The transfer mechanism 1418 is used to unload the harvested crops from the storage sections 1558 onto the dock.

In a sixth step 3212, the transport unit 1400 continues to move between the operating unit(s) 1200 and the dock 1100 in accordance with its schedule, and collect and/or store crops 14 until the schedule is complete. The techniques described with reference to determining when to cease operations of the mapping unit 1300 (i.e. in the sixth step 2212 of the method 2200 of operating the mapping unit) may be used to determine when to cease operations of the transport unit. The transport unit 1400 may also cease transporting crops if a halting command is received from the central processor (for example if the central processor determines that enough crops have been collected, if the volume of the crops within the large storage space surpasses a threshold value, or if the collecting process is cancelled). Additionally the transport unit 1400 may cease transporting if a particular threshold is exceeded or if a particular condition is satisfied (for example, if battery charge falls below a certain level).

In an optional seventh step 3214, if maintenance of the transport unit 1400 is required (for example, if it is detected that battery level falls below a pre-determined threshold), the transport unit is arranged to travel to a predetermined location for maintenance, or alternatively to the maintenance unit 1500. The maintenance unit 1500 may also navigate to the transport unit 1400 to perform maintenance, which may minimise interruptions to the transporting process.

Once the route is complete, the transport unit 1400 then ceases operation until further instructions are received. The transport unit may return to the dock 1100 or may sit idle in any area away from the greenhouse plants 12.

Maintenance Unit

FIG. 12 shows a schematic diagram of a maintenance unit 1500 according to the present invention. The maintenance unit is used to keep other units (i.e. mapping units 1200, operating units 1300, transport units 1400, and other maintenance units 1500) in an operating condition, so as to minimise the amount of time during which they are not usable—and thereby improve the speed and/or reliability of a harvesting process.

Similarly to previous units, the maintenance unit 1500 comprises a ‘pipe-rail’ trolley 1502 having wheels 1504. Other components of the operating unit are mounted on the trolley—in particular, such other components comprise a camera 1506, processor 1508, a battery 1510, a motion controller 1512, an antenna 1514, a maintenance mechanism 1518, and a storage space 1520 for components.

Any components of the maintenance unit 1500 which can also be found upon previously discussed units operate in the same way, so that, for example, the movement of the maintenance unit 1500 uses the same mechanisms as that of the mapping unit 1300.

Similarly to the transport mechanism 1418 of the transport unit 1400, the maintenance unit 1500 is a manipulation device such as a robotic arm, which may optionally be mounted on a moving platform. More specifically, the transfer mechanism 1418 is a robotic arm which is able to position its end effector with less than six degrees of freedom, such as a ‘cylindrical’ or ‘Cartesian’ arm (as previously described). The end effector is a pair of jaws configured for use in maintenance operations (for example, swapping components). The maintenance mechanism may also comprise, or may be interchangeable with, a variety of tools, such as screwdrivers and wrenches, which can be used in repair procedures. Such tools may be gripped by the end effector for use in maintenance. A software connection device may be included alongside, or on, the maintenance mechanism to enable software related maintenance to be performed. Any components necessary for maintenance (optionally including the tools) are transported using a storage space 1520 on the maintenance unit 1500.

FIG. 13 shows a flow diagram illustrating a method of operating the maintenance unit 1500. In a first step 4202, the central processor generates a schedule for use of one or more transport units 1400. Within this schedule actions may be given a priority depending on the value of a device and the state of a device, i.e. an operating unit 1200 may be considered more valuable than a transport unit 1400, and a broken unit may be considered a higher priority than a unit which needs routine maintenance. The schedule is partially based on known required actions (such as routine maintenance), and may also be dynamically updated based on events (such as a unit breaking down—in which case a maintenance unit is dispatched to the location of the broken unit as a priority). In an example schedule, a maintenance unit may be used alongside another unit—for example, a maintenance unit may follow an operating unit 1200, so that any unexpected malfunctions within the operating unit can be quickly addressed.

In a second step 4204, the maintenance unit 1500 receives notification that it should begin operation—for example, the transport unit may receive a communication from the central processor via the antenna 1414, where the communication comprises details of the schedule.

In a third step 4206, the maintenance unit 1500 travels to a location of a particular unit from a starting position, using the previously described components for navigating and moving. The starting position may be at the dock 1100, or alternatively at an idle position outside of the interstitial rows 18. In an alternative, the maintenance unit travels to a particular part of the greenhouse that requires maintenance, such as an air conditioning unit or humidity controller.

In a fourth step 4208, the maintenance unit 1500 performs a maintenance action on a unit (or optionally on a part of the greenhouse). Such actions may include a repair action, a cleaning action, or a routine maintenance action, where this action is carried out using the maintenance mechanism 1518. Components which are required for a maintenance action are stored in the storage space 1520 on the maintenance unit, so that a malfunctioning component on a unit can be replaced with a working component stored in the storage space, where the malfunctioning component can be transferred into the storage space. The storage space may be divided to separate components by type, or by condition.

Other examples of specific maintenance actions include: unscrewing or rescrewing a panel to access components; changing a battery; charging a battery (optionally, wirelessly); changing wiring; re-wiring; rebooting; changing a tyre/wheel; mending a puncture; cleaning (for example, cleaning a camera); and removing blockages.

In an optional fifth step 4210, the components stored within the storage space 1520 of the maintenance unit 1500 are periodically transferred to or from a storage space contained at the dock or in another location in the greenhouse 10, for example so as to remove broken components or fetch fresh components. The storage space used may depend on the component being transferred, where components related to separate units may be contained in different location, or universal components, such as batteries, may be stored together. The component transfer may take place when a weight or volume threshold of storage space upon the maintenance unit used is passed. Transfers may also take place either at regular time periods, or depending on maintenance events, for example a maintenance unit may transfer components to or from a storage space following each repair process.

In a sixth step 4212, the maintenance unit 1500 continues to move along the route and perform maintenance/repair/cleaning procedures until the schedule is completed. The techniques described with reference to determining when to cease operations of the mapping unit 1300 (i.e. in the sixth step 2212 of the method 2200 of operating the mapping unit) may be used to determine when to cease operations of the maintenance unit. The maintenance unit 1500 may also cease transporting if a halting command is received from the central processor (for example if the central processor determines that enough units are now functioning, if the volume of components within a storage space falls below a threshold value, or if the maintenance process is cancelled). Additionally the maintenance unit 1400 may cease transporting if a particular threshold is exceeded (for example, if battery charge falls below a certain level).

In an optional seventh step 4214, if maintenance of the maintenance unit 1500 is required (for example, if it is detected that battery level falls below a pre-determined threshold), the maintenance unit is arranged to travel to a predetermined location for maintenance, or alternatively to another maintenance unit 1500. Another maintenance unit 1500 may also navigate to the maintenance unit requiring maintenance 1500. A maintenance unit may have some capacity to carry out maintenance procedures on itself to minimise the reliance upon other maintenance units.

Once the route is complete, the maintenance unit 1500 then ceases operation until further instructions are received. The maintenance unit may return to the dock 1100 or may sit idle in any area away from the greenhouse plants 12.

Dock

FIG. 14 shows a schematic diagram of a dock 1100 according to the present invention. As mentioned, the dock 1100 is located at a fixed position within or near the growing environment (for example, the dock may be anchored to a wall or floor of the growing environment) and acts as a control node for the other units. The dock may also be capable of storing or otherwise engaging with the various units of the system 1000. The dock comprises the central processor 1112, which is arranged to generate schedules and routes and thereby control all of the other units. The dock further comprises an antenna 1114 for communicating with the other units via the wireless network, a docking section 1120 (which may be formed as a wall) for physically receiving the units, and a battery 1108. The docking section includes shaped portions for receiving units (optionally where the shaped portions match the shape of each unit), such that the units can drive directly into the dock.

An example unit 1150 (representing any of the units described herein) is also shown. The unit comprises a dock connection 1122, which is a data connection (such as a USB connection, or an Ethernet connection) located at the front or rear of the unit and arranged to interface with the dock when the unit is engaged with the dock to allow transfer of electronic data between the unit and the dock. The unit may also receive charge for a battery via the dock connection. The dock connection is located so as to be received into a corresponding connection on the docking section 1120, optionally where the dock connection is a male connection and the connection on the docking section is a female connection (or vice versa). In an alternative, no physical dock connection is provided, and the unit interacts purely wirelessly with the dock (for example, the unit may be charged inductively and may communicate data wirelessly, for example via Wi-Fi).

As mentioned, the dock 1100 is arranged to receive harvested crops 14 (for example, via a hatch on the docking section 1120) which are then transported away from the greenhouse 10, for example via conveyor belt. The dock 1100 may also contain space for large scale storage of crops.

FIG. 15 shows a flow diagram illustrating a method of operating the dock 1100. In a first step 5202, the dock waits in an idling (i.e. power saving) mode until a unit physically connects to the docking section 1120, where this connection is optionally aided by the dock in a second step 5204 using, for example, visual clues, network clues, or a physical guidance means (such as guide rails extending out of the dock). The physical guidance means may also be used to slow down a unit which is travelling too quickly, in order to prevent damage to either the unit or the dock.

In a third step 5206, the dock 1100 is used to transfer data, charge the connected unit, and load or unload components or crops (as mentioned, the transport unit uses the transfer mechanism 1418 to transfer (i.e. unload) crops from the transfer unit to the dock). To decrease required docking time, the dock 1100 may in some circumstances swap a depleted battery contained within a unit for a charged battery. This depleted battery may then be charged without requiring the unit to remain docked.

In a fourth step 5208, the dock 1100 transmits data regarding the units and the crops 14 to a cloud server/network, as will be described later on.

In an optional fifth step 5210, other units may be summoned by the dock, for example in order to provide further assistance—for example, the camera of the unit may be used in order to locate units and/or locations, or an additional transport unit 1300 may be used to assist in unloading crops from a first transfer unit.

Growing Environment

As mentioned, the greenhouse 10 (or other growing environment) itself includes modifications to assist in allowing the units to navigate—in particular, navigational aids (which are detectable via the camera of each unit) are placed throughout the greenhouse, for example at the edge of and/or within the interstitial rows 18. Such navigational aids may identify the nearby row 16, so as to allow the units to locate themselves. The navigational aids may also be present on or around the dock 1100 to assist the units in navigating to the dock.

Control System

FIG. 16 shows a hierarchical dependency diagram illustrating connections between components of the system 1000.

A configuration User Interface (UI) 102 is connected to a controlling unit 104 (i.e. the central processor 1112 in the dock 1100 and/or the cloud server that it communicates with). Using a communication network management system 106, each type of operation (i.e. image acquisition 108 for mapping units 1300, harvesting (or other operations) 110 for operating units 1200, transporting 114 for transport units 1400, and maintenance 112 for maintenance units 1500) is scheduled and coordinated as previously described with reference to other figures. These schedules are then transmitted to units via a wireless connection, whereupon each unit performs its associated action.

As mentioned, the central processor 1112 interfaces with a cloud server, which may be used to perform additional processing operations (or alternatively the majority of processing operations). A user can access the cloud server via the configuration UI 102, which itself may be accessed by a web portal or a software application.

The configuration UI 102 is configurable to schedule operations, for example mapping and transporting, as well as ancillary operations, such as charging and software updates. The user is able to schedule operations exactly, or alternatively may be able to set general parameters (e.g. ‘map twice an hour’), in which case the exact scheduling is determined by the controlling unit 104.

A user of the configuration UI 102 is able to set other preferences, such as a readiness-for-harvest threshold (for use in determining whether crops are to be harvested), a routine maintenance timetable, and safety settings, such as maximum operating speeds. An operator is also able to use the configuration UI 102 to register units to be controlled by the controlling unit 104. The operator may also input the plan of the greenhouse that is used in generating mapping data.

Information from each unit is coordinated using a communication network 106, so that all information about or from units is known to the controlling unit 104. Such information may include status updates, event notifications, location information, and detection information, such as mapping data. Communications may then be planned using knowledge of each unit's position and known information.

Alternatives and Extensions

It will be appreciated that the embodiment described above represents just one possible implementation of the system—many possible alternative implementations are also possible.

Although the system 1000 and method 2000 have principally been described with reference to harvesting (or performing other operations on) crops, it will be appreciated that they can equally be applied to various other related situations, such as moving items around a warehouse or factory.

In an alternative implementation of the system 1000, transport units 1400 (or other units) may be used to physically transfer data (such as mapping data, routes, etc.) between various units and the dock, either as a replacement or as an addition to wireless communications via antennae. This may be useful when no reliable wireless connection is available, or where it would be prohibitively expensive to set up such a connection. Data may be exchanged using the dock connection 1122 of each unit, or otherwise a similar data connection.

FIG. 17 shows a component diagram of a system 1000 for harvesting crops 14 in which transport units 1400 are used to transfer data. Solid connecting lines indicate data connections between the components of the system, while broken lines indicate connections over which harvested crops are transferred. Data can be transferred between any of the units, but only the transport units 1400 are configured to transfer data to and from the dock 1100—as will be appreciated, this is implemented because the transport unit is in any case travelling to the dock and back. Harvested crops are transferred from operating units to transport units and finally to the dock.

Although the system 1000 and method 2000 have principally been described with reference to crops 14 which are grown on a plant 14 and are removed from the plant during harvesting, in particular crops grown on trusses or supporting parts of a plant 14, they may equally be applied to any kind of fruit, vegetable, or other crop. For example, the ‘crop’ may be the whole plant, rather than part of a plant. Where the crops 14 are root vegetables, the operating unit 1200 may be adapted to dig out the crops 14.

Within the greenhouse a target area 20 may consist of the entirety of the greenhouse, or a subsection. There may be multiple target areas, where within each target area a different group of units is used, for example each area may use a different operating unit 1200. There may be some common units, so that, for example a shared dock 1100 may be used for every area, or the same maintenance units 1500 may be used for each area.

Components or functions from any of the described units may be interchangeable, so that any unit may perform any of the functions of another unit or several units. In particular, an operating unit 1200 may perform the function of a mapping unit 1400 without modification. A transport unit may, for example, also operate as a maintenance unit where the transfer mechanism 1418 may be used as a maintenance mechanism 1518, or a separate maintenance mechanism may be present on the trolley 1402 of the transport unit. In some systems the features of every unit may be combined, so that a single unit performs each of the described functions.

Components may be replaced, either manually or automatically, where the same base could be used with a different manipulation device or end effector, for example a transport unit 1400 may be used as a maintenance unit 1500 by replacing the transfer mechanism 1418 with a maintenance mechanism 1518. Such a replacement may occur automatically—for example, if a maintenance unit is removed from the system, another unit may automatically convert into a maintenance unit 1500. This could be based upon a minimum desirable number of each unit in a system, or an optimised unit balance. Multiple different end effectors may be used with a single manipulation device, optionally wherein the end effector can be changed as the manipulation device is being used. The use of multiple end effectors allows for each end effector to be tailored for specific purposes—for example, the end effectors may be formed as a gripper, a cutter, a camera, a probe, a sensor, etc.

Although the manipulation device used on several of the units has generally been described as a cylindrical or Cartesian robotic arm, it will be appreciated that any form of articulated arm that can be controlled via electronic signals may alternatively be adapted for use on a unit. Examples of suitable robotic arms include spherical, delta, polar, articulated, vertically actuated, slide-based, rope guided, and jointed (e.g. 6 degree of freedom) robot arms may be used. Other alternative manipulation devices include SCARA (selective compliance assembly robot arms), parallel manipulators, anthropomorphic robots, and multiple independent actuators (such as linear actuators, or linear and rotational actuators). It will be appreciated that the described manipulation devices may of course be combined or otherwise integrated together as appropriate.

There may be any number of each unit used within a greenhouse 10, or within an area of a greenhouse. Certain units may be assigned to a particular interstitial row 18, where there may be one of each type of unit per interstitial row. Alternatively, there may be a greater number of some types of units per interstitial row, where a certain ratio of unit types may be advantageous.

In an alternative, the units may be more specialised than described—for example there may be different specialised repair units instead of a general maintenance unit 1500. The components of a single unit may be not contained within a single trolley. For example, a mapping unit 1300 may be split into multiple parts, where one or more cameras 1306 located away from the trolley 1302.

The units may change their size or shape as appropriate, either by replacing components, or by using extendable components. This may allow a mapping unit 1300 to gain a better view of a location, or an operating unit 1200 to optimise the form of the operator 1218. For example, a longer robotic arm may be desirable for a sparse area of crops 14 or a plant 12 which is large. Units may be optionally arranged to dynamically reconfigure themselves (or be dynamically reconfigured by another unit or the dock) in response to requirements. In one example, a unit may be reconfigured into a different kind of unit—for example, the addition of an operator 1218 and storage space 1220 may serve to convert a mapping unit into an operating unit.

A unit of a certain type may optionally be integrated to at least some extent with another unit—for example, a transport unit 1400 may be an integrated part of an operating unit 1200, which detaches to offload harvested crops at the dock at regular intervals, or the transport unit 1400 may trail behind the operating unit 1200. In a further example, a unit (referred to as a ‘master unit’) may deploy smaller units (which may be referred to as ‘sub-units’) in order to perform particular tasks, such as mapping or harvesting. In this scenario the master unit may act as a mobile version of the dock 1100.

Any components described for use in a unit could be provided as fixed components within the growing environment 10, for example one or more operators 1218 may be located at fixed locations within the growing environment 10.

Although the described system 1000 and method 2000 have principally been described with reference to units that travel using wheels, they may equally be applied to units which use another form of movement, for example the units may be on tracks or rails, use a pulley system, or use an overhead gantry.

The units may travel through any medium, so that units may move on or under water, or through the air (i.e. the units may be unmanned aerial vehicles (UAVs) or ‘drones’). Units may have a constrained movement range, for example they may move along a limited number of tracks, or they may be able to move freely. Separate units may operate using different travelling means: for example operating units 1200 may follow a predictable path, moving along an interstitial row 18, where a ‘pipe-rail’ system is used. Maintenance units 1500 may use a mechanism which allows unconstrained travel, such as a rotor system enabling flight, as they may be required to service units in a number of interstitial rows at any point within these rows. Units may contain a plurality of travelling mechanisms, where they can switch between two such mechanisms.

The means for controlling and powering motion may be contained on each unit or may be contained elsewhere. For example, a pulley system may be driven at the location of the pulley, so that a unit does not need to power its own motion and does not require a motion controller. Manual, electrical, magnetic, wind, forced air, or any other means (for example a flywheel with stored kinetic energy) may be used to power motion.

Optionally, any or all of the units comprise one or more torches (or other light sources) to allow the camera of each unit to operate as desired in poorly lit environments.

Although all of the units have been described as including a camera at least for the purpose of navigation, it will be appreciated that various other non-visual sensors may be used additionally or in place of the camera for navigation. In particular, GPS systems may be used for navigation (as described), and/or the units may incorporate means for surveying by means of radar, lidar, or ultrasound.

The units may also be able to locate themselves using odometry (for example based on servomotors or encoders capable of detecting the rotation of the wheels, or indeed any other motion sensors, configured as odometers), where probabilistic, deterministic, and/or dead reckoning methods are used to determine the position of the unit. The unit may receive further inputs for use in navigation from magnetic sensors (which may be used to detect the location of navigation aids or other objects, such as ferrous wires, within the growing environment), proximity sensors, or wireless communication means (which may be used to detect the signal strength of e.g. a radio signal associated with a transmitter at a predetermined location within the growing environment). This may allow a unit to simply follow a marked path, rather than navigating for itself independently using e.g. computer vision techniques. The use of non-visual sensors in navigation is particularly useful in low-light conditions and in extremely bright conditions (e.g. in an indoor farm using high intensity light).

Optionally, units may perform maze search algorithms in order to navigate and/or determine whether to cease or continue operations (e.g. in determining whether to continue mapping). Random searches may optionally be used to determine start or end positions for a particular route and/or operation.

Optionally, physical feedback (i.e. interaction with objects or parts of the growing environment that are detectable via the sensors of each or some of the units) may be used to determine problems and/or incompleteness with mapping data and/or plans/maps of the target area/growing environment, for example problems caused if the growing environment changes unexpectedly.

Optionally, each of the units comprise user input devices (such as a touch screen presenting a number of options, or a number of buttons) to allow a user to control the unit (either completely or in a limited sense), for example by overriding instructions from the processor in the dock 1100. A user may be able to use the user interface device to assume control of a particular autonomous unit, for example when the unit is on course to collide with an obstacle, or where another error has occurred or will imminently occur.

Optionally, any or all of the units comprise a collision detection mechanism, which may be used during motion. This may, for example, be a detector, such as a distance measuring system, or a virtual system, such as a probabilistic model based upon historical data, where a route may be planned which avoids previous collision locations.

Optionally, any or all of the units are capable of cleaning themselves (or are capable of doing so with the assistance of other units or by using part of the growing environment 10)—for example, units may wipe themselves down (for example against a component of the growing environment), clean themselves using water or another liquid, drive through water or another liquid, or drive past an air blower or similar component.

Optionally, any or all of the units comprise an item detection mechanism, where units may detect any item in the path of the unit or around the unit which may cause inefficiency or damage, for example by using the camera in conjunction with computer vision and object recognition techniques. Such detection may result in an alert, such as an alarm or a message which may be accompanied by an image or description of the item. Such an alarm or message may be transmitted to the central processor 1122, and may be visible via the configuration UI 102. The item detection mechanism may be combined with an item classification mechanism.

Each unit may be programmed to optimise a variety of performance metrics, where for example, there may be an option to perform tasks as quickly as possible, as accurately as possible, or a compromise between these goals. This optimisation may depend on a location or a time, for example a mapping unit 1300 may be programmed to map a crop 14 area quickly, while still achieving a minimum sufficient accuracy. This mapping unit may map a subsection of this area more accurately when an unusual item is detected, or when another unit requires more information about an area. In another example, the mapping unit may be arranged to select a speed of movement in dependence on a pre-determined quality required (on the basis that faster movement speed tends to reduce the quality of the captured visual data). Similarly an operating unit 1200 may be able to operate on certain crops 14 quickly, but other crops 14 may require a more precise operating process which may require an approach which prioritises accuracy. The optimisation may be selected by a person, by the dock 1100, or by the unit where it may be determined based on a feature of the crops 14 or on the time.

Although the described method 2000 primarily considers route generation 2600 and unit operation which maximises time efficiency (i.e. where crops 14 are harvested in a minimum time), other efficiencies may be prioritised (or a balance between efficiencies may be selected). For example, the system 1000 may be configured to minimise unit movement, wear, damage to crops or plants, or energy use.

Units and the dock 1100 may receive data, for example schedules or mapping data, using any means of receiving data. This may comprise a physical or a wireless connection, so that each unit may receive data using, for example, an area network connection or a Bluetooth ® connection. This connection may be continuous or may only be established when data transfer is necessary. A plurality of connection methods may be used, for example the dock 1100 may receive data from an external connection using an internet connection, and transmit data to units using a Bluetooth ® connection. Units may use a physical link which is connected before transmitting data, and disconnected when transmission is complete, or there may be a constant physical link.

Optionally, any or all of the units may optionally be configured to be teleoperated by a human user, a server, or another unit rather than operating autonomously, either on a temporary or permanent basis. Optionally, inputs from the sensors of other units (such as cameras) made be shared with a unit to assist in navigation of that unit (either autonomously or as part of teleoperation).

Optionally, any or all of the units may be arranged to signal for the attention of a human operator, for example by emitting a sound or by issuing a notification to the server. Such signalling may be required, for example, when a unit requires access (e.g. through a door).

Although the described system 1000 and method 2000 have principally been described with reference to units that are powered using batteries, they may equally apply to units that use any form of power—for example units may be connected to a power grid, either wirelessly or using wires. In particular, the dock may be connected to a permanent or semi-permanent power source, such as a generator. Where batteries are used, either wired or wireless charging methods may be used.

Optionally, any or all of the units comprise sensors for obtaining information about parameters of the growing environment, such as Carbon dioxide levels, humidity, or light levels. This information may be transmitted to any other units or to the dock 1100

Any unit, or the dock 1100, may be integrated with control systems within the building, so that the environment may be altered in dependence on requirements. The mapping unit 1300 may, for example, be able to cause the lighting within the growing environment 10 to be modified in the proximity of the mapping unit so as to improve the capture of visual data.

Data (in particular visual data) obtained from any unit may be used for predictions about the crop, for example an expected yield or harvest time. Such a prediction may be improved by combining data from multiple units or multiple recording times, so that a mapping unit 1300 may use multiple mapping runs to create a prediction. These predictions may be used to suggest or implement modifications to the growing environment, for example the humidity (or other factors) may be modified if data suggests the plants 12 are growing poorly.

Any unit may send notifications to the dock 1100 via the wireless network. These notifications may be sent at certain times, upon the completion of certain actions, or if instruction is needed. These notifications may be in the form of progress reports.

Optionally, any or all of the units are arranged to calibrate certain components such as wheels or robotic arms. Any offset or error detected in the calibration may be corrected, or accounted for in subsequent operations. This may occur periodically or may be triggered by detected substandard performance.

Optionally, any or all of the units are arranged to perform status checks. For example, components may be tested to ensure that they are functioning correctly and batteries may be tested to ensure that they may carry sufficient charge. Such status information may be stored, and notifications related to component breakages or maintenance may be issued. Such notifications may contain information about, for example, load status, battery status, errors, location, schedule progress, and/or nearby objects. Such a transmission may cause the central processor to implement any of the following solutions: rerouting any unit, possibly to complete the schedule of a broken unit or avoid a hazard; summoning a maintenance unit 1500 or a transport unit 1400; or navigating the unit to a charging point (such as the dock 1100). A schedule may be modified so that a unit may access, for example, a charging point when the battery level falls below a threshold value.

Optionally, any or all of the units comprise a cover to reduce the intrusion of water or dust. The cover may allow an effector, such as an operator 1218, to pass through.

Any unit may contain components which allow interaction with one or more operators, for example a seat may be included. A person may monitor the units, act as quality control, or modify aspects of a unit's behaviour based upon observations using the configuration UI 102.

Any of the processes performed by the dock 1100, such as the generation of maps 2400, may be alternatively performed by the units. This may include any processes which may be performed by a central processor, such as analysis or processing of map data, or route generation 2600. Such analysis processes may be performed during other operations, so that a mapping unit may simultaneously capture and analyse mapping data. Similarly, any of the processes performed by the dock may alternatively be performed at an external server (for example a cloud server), in which case the dock simply acts to forward the data to the server and receive a response.

In an alternative, no separate dock is provided, and the units each communicate directly with the external server. In a further alternative, the processing functions performed by the dock may be distributed among a number of units. In yet a further alternative, each unit is controlled individually, where unit operation and actions may be based upon data gathered by sensors on the unit.

Machine learning algorithms or a neural network may optionally be used to improve any aspect of the method, where machine learning may, for example, be used to optimise route generation 2600, improve predictions about yield, or identify crops within collected data, as described. Examples of suitable techniques and algorithms include reinforcement learning, deep convolutional neural networks, random forests, feature learning, artificial intelligence, and Bayesian networks, among others. Generally such techniques and algorithms are provided as computational algorithms which are trained on historic data collected from the units of the system 1000 and/or other similar systems 1000 (for example, those operating in a different growing environment) to output predictions or results (optionally including a confidence level).

Historic results data (i.e. previous results, maps, or routes) may be fed directly as an input into the models used for object recognition and route generation, which may assist in producing new or updated results (e.g. extrapolating a new location of a particular crop based on historic mapping data and a predicted growth rate). The models may use organic modelling using rules, Al, or other techniques in order to produce such updated results. Temperature, light levels (current and recent), and/or other signals can be used to inform such models. In an alternative, simply applying a rough scale-up factor, error acceptance, or rounding to a set of results (such as a generated map) may be sufficient to ‘update’ the results in light of time passing.

Where multiple maps are created over time or where updated maps are extrapolated, the maps (and associated models) may incorporate spatial-temporal modelling techniques. Maps of different time periods may be averaged (either in weighted or unweighted fashion, by e.g. recency or another property) and/or fuzzy techniques may be used. As previously mentioned, a speed of movement of a mapping unit 1300 during mapping may be selected on the basis of a pre-determined data quality requirement—this may be used to update maps in combination with historic data, for example where one ‘slow’ (and so high quality) mapping run is performed occasionally (for example once a week), while faster (and so lower quality) mapping runs may be performed more frequently (such as once a day). This arrangement may keep the map of crops sufficiently up-to-date and accurate, while minimising the amount of mapping that is performed. Further improvement may be possible by operating the mapping units in different runs using different sensors or different configurations (e.g. sample frequency), for example on an averaging or differential basis.

Indicators related to the practical implementation of mapping and/or harvesting, such as how difficult it is to map or harvest a particular area (measured by e.g. number of errors, or time taken) may be used as an input in maps and/or in generating routes.

Historic results data may also be used as feedback for machine learning models, for example to correct model weights or to test against alternative machine learning network designs (where the alternatives may relate to disabling layers, setting early stopping, including further convolution/pooling, or classical computer vision techniques).

Historical data may be used to improve the efficiency or the accuracy of the mapping unit 1300, where locations of interest may be detected, or predicted, using past data. Locations may be mapped relative to this past data.

As previously described, units are generally operated in accordance with schedules which are defined on the basis of predetermined timings (or other requirements) and/or in response to events. Such schedules may optionally be dynamically adapted in response to events, capacity, need, and/or efficiency for example so as to reallocate units throughout the growing environment. For example, the frequency of full or partial mapping runs may be dynamically determined based on any of: events, historic frequency, and observed or expected changes. A detected change might be, for example, a detected error in operating on crops as a result of a divergence from the mapping data, which may cause a mapping run to be started in order to improve the quality of mapping data. The quality of mapping data may be tested, for example, by comparison of the mapping data against one or more reference objects in the growing environment (such as particular navigational aids). Generated routes between crops may also be dynamically adapted in response to events, capacity, need, and/or efficiency—for example, if an operating unit 1200 breaks down, the routes for all other operating units may be recalculated so that the other operating units can cover the broken-down operating unit's previously allocated route.

There may be limitations on the information that can be sent to each unit—as such, a simple interface may be used. The system may be controlled via a bespoke programming language.

The system 1000 may be integrated with another system to receive relevant data which affects operations, for example the system may be able to receive order information to supermarkets, where an appropriate amount of a crop 14 could then be harvested in dependence on the order information. The system may also be integrated with building control systems, or planting systems, where the amount of crops grown may be selected based upon the order information. The system may also gather information about crops which can be used to improve the yields, such as monitoring inefficiencies, or wastage.

The central processor may optionally gather information about each unit, where the performance may be monitored and alerts generated if performance drops below a certain threshold. The central processor may be able to transfer resources to improve performance, for example by allocating more bandwidth to a unit which is transferring data slowly.

The central processor may optionally perform security operations, where data is logged and any user attempting to change settings must complete an authentication process.

The central processor may optionally track relevant goods, such as incoming and outgoing crops 14. This tracking could be used to trace crops, where blockchain technology may be used as part of the tracking process.

As an alternative to being located in the dock 1100, the central processor may operate as a standalone system, such as being implemented on an offline computer, or may be based upon a network, where it may be controlled through, for example, a browser. The central processor may request further network resources when these would increase performance, or organise tasks based on the resources available.

The central processor may optionally use external data to improve the performance of the environment, for example data about the weather may be used to ensure that crop yield is maximised, or economic data may be used to harvest at an optimal time.

The central processor may be able to create, pause, or delete operation requests, so that the operations of any unit could be cancelled.

The central processor may use parallel components for increased performance, where this could also be used for redundancy, for example Redundant Array of Independent Disks (RAID) servers may be used. Regular backups may be used to ensure that no data is lost, the backup schedule may be based upon time or upon a perceived risk, for example a backup may be performed if a storm is expected.

Information (including mapping data, generated routes, records of crops, visual data, etc.) may be stored as raw data, or may be compressed to conserve space. Information may be encrypted for security reasons. Information may be shared between various such systems 1000 where the accumulated information is used to improve performance.

The central processor may be arranged to recommend cutting/pruning or growing techniques to optimise yield or unit performance, for example crops may be grown in zigzag formations. Simulations may be performed in order to perform this optimisation or to provide information to an operator.

Any calculations may be performed using appropriate devices, such as Graphical Processing Units (GPUs) or Field Programmable Gate Arrays (FPGAs).

The system 1000 may require drivers to communicate with each unit. Communications between units may also require specific formats of data, where any conversions may be performed by the system 100.

The system 1000 may optionally provide a means for a person to view information from each unit, for example viewing a live feed from a camera 1206. There may be an option for a person to make a decision based upon this feed, for example deciding whether a crop 14 should be operated on.

Mapping Unit

Optionally, the visual data received from the mapping unit 1300 is used to determine whether the crop is to be operated on, instead of or as a preliminary step to the determination using visual data from the operating unit 1200.

In an alternative, no separate mapping unit 1300 is used in the system 1000, and instead a plurality of fixed cameras (or one or more movable PTZ cameras) in the growing environment 10 (for example, mounted on raised platforms in the growing environment) are used to provide a ‘world-scene view’ of plants 12 and crops 14, from which mapping data (for use in the method 200) may be produced.

Although the described mapping unit 1300 uses a camera 1306 which collected visual data, any suitable sensor may be used (either as an alternative or in addition), for example an infrared or ultraviolet detector, or a smell or touch based detector. The sensor used may be adjusted dynamically—for example, a unit may automatically switch from a camera to an infrared sensor at night.

Optionally, the mapping unit 1300 may comprise means (such as an actuable robotic arm or other manipulation device) to move any crops 14 or items within the growing environment 10 in order to improve sensor detection, for example a crop may be moved to view the area behind the crop.

Optionally, the mapping unit 1300 uses visual data or other data captured from sensors to inform other units or the dock 1100 about a feature of the crop 14 or plant 12, for example the mapping unit may detect the size of the plant 12 and identify that special harvesting is required—for example, the operating unit 1200 used may need to contain a large operator 1218 or an operator with a long reach. The visual data may also be used to classify any feature of the crop, for example the type of crops present, the ripeness or readiness for harvest of any of the crops, or potentially damaged crops. Records may be stored about any one or more individual crops 14 so that past data may be used to make predictions about the yield of a crop 14.

Optionally, the mapping unit 1200 is arranged to pre-process the captured visual data, for example by filtering and/or compressing the data, before the data is transmitted to the central processor.

Optionally, along with generating mapping data, the captured visual data may be used to create a representation of the growing environment 10, which may indicate areas or objects of interest, or give further information about the crops. This may be a visual representation, a mathematical representation or a hybrid visual/mathematical representation.

The mapping data may also be used to create a map using a known feature within a section of the target area 20. For example, crops 14 may be mapped relative to a marker, where there may be multiple markers corresponding to different sections of the target area. Crops may also be located relative to a mapping unit 1200.

Although the map of crops has generally been described as being a 3D or 2D map, in certain circumstances it may be a 1D map, for example where each data point relates to the position of a crop along a particular row at a particular height. The mapping unit may include a camera adapted as a line scanner in order to generate such mapping data.

The visual data may be used to map crops 14 based upon features of the crops, so that separate maps may be created based upon the type of crop, the ripeness or readiness for harvest of each crop, or a combination of features. Routes may be generated accordingly based on a plurality of these separate maps.

Operating Unit

The determination about whether a crop 14 should be operated on may be (at least partially) based on inputs from a variety of optional sensors provided on the operating unit 1300, for example a chemical sensor for detecting an emission from a crop 14. The sensing may be passive or active—for example, a laser may be used to burn a portion of a crop to provoke a chemical response. The data may be compared against a trained classifier (which may be multi-modal in nature) to determine whether the crop should be operated on. Other examples of suitable sensors include infrared sensors (or other sensors of electromagnetic light), and moisture sensors. The operator 1218 may also be used as part of the determination about whether a crop should be operated on. In one example, the end effector is used to grasp and gently squeeze the crop—where the end effector comprises pressure sensors, these may be used to acquire an indication of the firmness of the crop. The operator may also be used to measure the force required to deflect the crop a certain distance from the crop, thereby providing a rough indication of weight. The signals received from the sensors are used as inputs to the described trained classifier thereby to obtain an indication of the readiness of the crop for harvesting. The classifier may also receive further external inputs to affect processing—for example, where weather conditions are likely to worsen, the classifier may be configured to allow crops to be picked earlier or on the basis of less stringent requirements than otherwise.

Optionally, the operator 1218 comprises (or is arranged to be capable of operating) one or more tools for picking, cutting, grinding, squeezing, crushing, or shaking. An operator may use torsional force to tear a plant 12 to harvest a crop 14, or a suction pump to harvest a crop 14. Multiple operators 1218 may be included on an operating unit 1200, where each mechanism may perform a different process. Mechanisms of varying complexity, for instance with differing degrees of freedom, may be included, where a more complex robotic manipulation device may only be used when necessary, for example for hard to reach crops 14.

The operator 1218 and/or other components of the operating unit 1300 may optionally be used to perform non-harvesting related operations, for example trimming/pruning a plant 12, applying pesticides, planting or replanting crops, maintaining crops, clearing parts of plants or debris around the growing environment 10, or releasing bees into the growing environment. The operator 1218 may also be used to perform tests, such as force stress tests, which may be used to gather data about crops 14.

The operating unit 1200 may work in combination with another plant treatment device, such as a de-leafer, to improve efficiency.

During harvesting, the crop 14 may optionally be cut to a specified length, or the cutting length may be determined by the operating unit 1200 at the time of harvesting depending on a feature of the crop 14, such as its size.

The operating unit 1200 may optionally communicate, directly or indirectly, with other units or the dock 1100 to identify locations of interest where action may be desirable. For example, a mapping unit 1300 may be requested to acquire an improved map of a location or area.

Optionally, the operating unit 1300 comprises a mechanism for processing crops 14 after harvest, for example a mechanism for removing crops from trusses, or a crushing mechanism may extract juice from an orange after an operator 1218 has picked the orange. Such a processing mechanism may be included in the operator or may be separate.

Optionally, the storage space 1220 of the operating unit 1300 may be refrigerated. Optionally, the storage space is covered by a door or hatch to prevent loss of crops 14.

The harvesting means 1418 may be able to offload crops 14 to the transport unit 1400, for example using the operator 1218. A separate offloading mechanism may also be provided.

In an alternative, the weighing/sorting mechanism 1450 described with reference to the transport unit 1400 may be included instead of or in addition to the storage space 1220. In such a case, the transport unit may include storage space in place of the weighing/sorting mechanism, or alternatively the transport unit may not be part of the system 1000.

Transport Unit

In an alternative, the transfer mechanism 1418 is not a robotic arm, and instead may take the form of a mechanism arranged to co-operate with a corresponding mechanism integrated into the storage space 1220 of the operating unit 1200. For example, the transport unit and the operating unit may comprise co-operating sliding doors, which are used in conjunction with sloped sections to transfer the crops to the transfer unit. Alternatively, a container located in the storage space of the operating unit may be transferred onto the transport unit, for example using conveyor belts on the transport unit/operating unit. In a further alternative, the operating unit may be configured simply to angle the storage space so as to tip or drop the crops onto the transport unit. Further alternative transfer mechanisms include suction mechanisms, piping, ducting, scoops, chutes, conveyor belts, forced air mechanisms, or thermal lift mechanisms.

In an alternative, the operating unit 1200 is arranged to offload crops 14 at a predetermined location, in which case the transport unit 1400 navigates to the pre-determined location and transports the crops 14 to the dock 1100.

In an alternative, the transport unit 1400 is configured to transport crops 14 to a separate location (other than the dock 1100). For example, the transport unit may load crops onto an external vehicle (such as a lorry). The transport unit may of course also assist in unloading goods from an external vehicle.

As well as crops, the transport unit 1400 may also optionally be configured to transfer components used by the maintenance unit 1500. When the transport unit is transferring components, the operation of the transport unit is similar to that described, with the difference that components are collected instead of crops, and the transport unit will navigate to a maintenance unit instead of an operating unit 1300. Additionally components may be delivered to the maintenance unit, as well as collected from the maintenance unit.

The weighing section 1454 of the weighing/sorting mechanism 1450 may optionally also categorise other aspects of a crop 14, such as size, shape, or colour, using appropriate sensors. The weighing/sorting mechanism 1450 may optionally also contain a packaging section, so that crops 14 may be packaged after being sorted. This could be used in combination with weighing data to package crops in a bag of a certain weight. The weighing/sorting mechanism may optionally comprise means for refrigerating or freezing food.

Maintenance Unit

Optionally, the maintenance unit 1500 may be able to identify repairs that it is incapable of performing and request further assistance. In this regard, the maintenance unit 1500 may be able to identify error codes produced by any unit (for example, those visible on a screen of the unit) and recommend a course of action based upon the code.

Optionally, the maintenance unit 1500 comprises means for assisting in the movement of other units, such as a motor with high torque so that the maintenance unit can overcome any resistance from broken wheels of other units, to allow the maintenance unit to push broken units out of the way. The maintenance unit may also comprise means for overriding the (software or hardware) functions of other units, where the maintenance unit may be able to disengage the brakes of any other unit or reset any malfunctioning software.

Optionally, the data store of the maintenance unit 1500 comprises information about desired appearance and performance, where the maintenance unit may perform a visual comparison of a unit against said information (using the camera 1506) to identify any potential problems (for example, scratches). The maintenance unit 1500 may be able to observe a unit performing an operation and compare this to a desired, or threshold, performance, optionally based on a trained model.

Optionally, the maintenance unit 1500 is arranged to remove debris or obstacles from areas where the units traverse, so as to reduce the likelihood that a unit's movements are blocked or otherwise impaired. In this regard, the maintenance unit may comprise a scoop or plough to move obstacles, in particular to move obstacles away from the centre of the interstitial rows 18.

The maintenance unit 1500 may test components of the growing environment 10, such as safety barriers, to ensure that they have not been damaged or otherwise impaired. The maintenance unit may also comprise sensors for testing components—in particular, sensors for testing ‘pipe-rails’ of the growing environment for damage, leaks, and/or non-uniform temperature may be provided.

Crops 14 may optionally be monitored and tested by the maintenance unit 1500, where the maintenance unit may ensure that the crops 14 are not in danger of damage, and the appearance of the crops 14 is similar to that expected.

Dock

Although the dock 1100 has generally been described as a ‘wall’ having portions for receiving units, it may alternatively have various other physical forms. For example, the dock may include a carousel arrangement for receiving and storing units, which can assist in saving space. Alternatively, the dock may include conveyor belts or other mechanisms for moving the units, where the units are received at a single point or entrance to the dock and are then moved to appropriate locations in or on the dock.

Optionally, the dock 1100 may further comprise one or more robotic arms or other manipulation devices to assist in transferring crops 14 into the dock, and in other fine manipulation operations. Optionally, the dock further comprises a camera to monitor units in the vicinity of the dock. The use of a camera may allow computer vision techniques to be used to assist in the operation of the robotic arms.

The dock 1100 may optionally comprise environmental monitoring equipment, or sorting and packaging equipment. The dock 1100 may not be mobile, so that it may be desirable to connect large or heavy monitoring and packaging equipment to the dock 1100 instead of to a unit. Optionally, the dock further comprises loading and/or unloading facilities for batteries or other items (such as crops or parts for use in maintenance)

In addition to the dock connection 1122, a separate connection formed of pipes or tubes may be optionally provided on each of the units and the dock to transfer physical items between the units and dock 1100, such as fluids, components, or even crops 18. In an alternative, a power connection is provided separately to the dock connection on each of the units and the dock.

In an alternative, the system 1000 may comprise multiple docks 1100, or a single dock with multiple connection points (or multiple docks with multiple connection points), where a unit may be able to connect to a dock at a number of places in the growing environment 10. The dock may be separated into separate docks which may perform different operations, for example one dock may provide charging, and another dock may provide data transmission.

The dock 1100 may be configurable to provide multiple types of connection at varying heights/location. This may enable the dock to connect with a variety of units, and may ensure backward and forward compatibility if new units are produced.

The dock 1100 may be able to provide: software or hardware updates, information about the units, information about the growing environment 10, control systems for the units and the growing environment 10, for example in form of push notifications to a user device. The dock may further comprise means to compress data in order to speed up transmission and reduce data size. Data may also be encrypted by the dock.

Any operations described as being performed by the dock may be performed on a central system and vice versa, where this may depend upon processing power needed. A more powerful dock may be able to perform more functions without the need for a central system.

Growing Environment

Although the system and method of the invention has generally been described with reference to the growing environment being a greenhouse, it will be appreciated that the system and method may also be applied to other growing environments, such as various buildings, rooms, structures (for example forming part of an indoor farm), or an open field. The autonomous units may be adapted in dependence on the growing environment—for example, larger wheels may be used where the units are operated in an open field.

Where reference has been made to a greenhouse 10, this has generally been a greenhouse having a ‘pipe-rail’ system. It will be appreciated that the described system and method may equally be applied to any kind of greenhouse, whether or not it includes crops 14 mounted on frames and/or arranged in rows.

The growing environment 10 may optionally comprise a number of possible navigational aids, such as barcodes (such as ArUco markers), other visual reference materials, or guide wires. Such navigational aids (in particular guide wires) may optionally be deployed by units. In a further example, units may also be capable of laying rails on which crops are grown (or otherwise placing or moving other components of the growing environment).

Obstacles may optionally be made visually clearer to units, such as by colouring obstacles. Alternatively or additionally, certain obstacles may be configured to emit a non-visual signal which units can detect. Tags may optionally be provided, so that units can tag a location of interest, where these tags may be visual or may emit a signal. Contrasting backdrops to plants and/or crops 14 may be provided, which may improve the accuracy of detection of crops.

The growing environment 10 may optionally comprise additional communications means, such as wireless access points. Additional charging points may be included to allow units to charge without returning to the dock 1100. Safety features may be included in the growing environment—for example, sensors may be provided to detect the ingress of a person into the interstitial rows, in which case a signal may be transmitted to the central processor and the operation of all units may be suspended. Safety barriers may also be provided.

The growing environment 10 may optionally comprise a mechanism for optimising the amount of light received by the crops 14. For example, reflectors could be used to deflect light either away from or towards crops 14.

The growing environment 10 may optionally comprise integrated sensors to improve unit performance, such as force sensors which may be used to alert a controlling system when a unit is contacting a surface. Controllable systems, such as lighting or heating, may be provided to optimise crop yield or unit performance. The growing environment may further comprise sensors, such as camera, to assist in monitoring operation of the system 1000 (or monitoring the growing environment in general).

The growing environment 10 may also comprise air blowers to reduce obstruction of the interstitial rows 18, for example due to a build-up of leaves. Chutes and/or conveyor belts may also be provided for removing objects such as leaves from the growing environment 10, optionally where these are used in combination with the air blowers. The chutes and/or conveyor belts may also be used for removing other goods (such as crops 12 from the growing environment), optionally where separate chutes and/or conveyor belts are provided for different kinds of goods.

Artificial systems, such as artificial vines, may be provided to improve crop 14 growth. Systems for grafting crops 14 may also be provided.

The size of the interstitial rows 18 may optionally be adjustable, so that larger robots may be able to fit in these rows. In an example implementation, rows 16 of frames may be moveable so as to compress or expand the interstitial rows 18. This may also allow for more crops to be grown in the same area. Optionally, the rows 16 of frames are supported by wire and hung from a ceiling of the growing environment (in particular where the growing environments is a greenhouse), which may allow the vertical position of the rows to be varied (for example to layer the rows) to optimise heating and lighting for the crops throughout the growing environment. The position of the rows may then be adjusted dynamically in dependence on the growth of the plants and/or crops.

The growing environment 10 may use non-linear rows, such as spiral or circular rows. The rows 16 may be located closer together than in conventional greenhouses, as the units may require a reduced area in which to operate as compared to human crop harvesters.

In an alternative, the growing environment 10 may be configured to be adaptable, for example for different crops or growing conditions. For example, crop rows 16 could be raised or lowered, the soil type may be changed, or plant types may be changed. Similarly aspects of unit operation could be altered, such as the position of any rails on which units move.

Optionally, the growing environment 10 is configured to be formed by robotic units (in particular where the growing environment is a greenhouse), optionally the described units, where the growing environment may be designed so that it could be constructed autonomously. In this implementation the greenhouse may be described as a ‘pop-up’ greenhouse.

In general, it will be appreciated that the invention is primarily configured for use in a greenhouse (in particular a greenhouse including a pipe-rail system) consisting of a plurality of rows of crops, wherein plants are grown together in rows. Accordingly, there is no particular gap between plants—so there is no need to pick all crops on a particular plant before moving on to a further plant. Crops may therefore be picked on a per-row basis, rather than a per-plant basis. Since the speed of movement of an end effector is generally greater in the direction of the row (because the entire operating unit can move quickly up and down the row) than in an upwards/downwards direction, an efficient route for a harvesting a particular row can be generated based on the different speeds of movement of the end effector. For example, the route may include a strategy of “scanning” horizontally across a row so as to pick many crops or generally around a particular height, increasing the height of the end effector, and then “scanning” again at a different height.

The application of the system in a greenhouse may also reduce the burden on the computer vision and end effector positioning aspects of the system as compared to e.g. crops grown on a plurality of trees, where the crops may be more widely distributed. This may reduce processing time in using the system.

It will also be appreciated that the use of transport units, maintenance units and a dock for units provides a complete (self-contained) system for harvesting crops in a growing environment. Efficiency may be improved by the user of the dock, since this may provide a single location at which human operators may interact with the units (to the relatively minimal extent necessary). There may be no need for human operators to enter the growing environment, at least while any units are running, which may improve the safety of the growing environment.

It will further be appreciated that the use of separate “mapping” and “routing” processes (both of which are discrete and separated from a “harvesting” process) in respect of an entire growing environment may improve the efficiency of the system by allowing substantially all crops in the growing environment to be used in route planning.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed is:

1. A method of operating on crops in a target area, comprising:
using one or more sensors, capturing data related to crops in a target area;
mapping locations of the crops in the target area using the captured sensor data;
generating one or more routes between at least some of the crops in the target area based on the mapped locations; and
routing one or more operating units along the one or more routes thereby to operate on at least one of the crops.

2. A method according to claim 1, wherein capturing data related to crops in a target area comprises routing one or more mapping units through or around the target area; wherein the one or more mapping units comprise the one or more sensors.

3. A method according to claim 2, further comprising receiving indications of location from the one or more mapping units; wherein mapping locations of crops in a target area comprises locating crops in relation to the one or more mapping units.

4. A method according to claim 3, wherein mapping locations of crops in a target area comprises locating crops in relation to the locations at a particular time of the one or more mapping units.

5. A method according to any of claims 2 to 4, further comprising determining when to route the one or more mapping units through or around the target area.

6. A method according to claim 5, wherein said determining is in dependence on one or more of: a schedule; detected issues with the mapped locations of crops and/or generated routes; and observed or expected events associated with the growing environment.

7. A method according to any of claims 2 to 6, wherein mapping locations of crops in a target area comprises selecting a speed of movement of the one or more mapping units based on a predetermined quality requirement for the captured data.

8. A method according to any of claims 2 to 7, wherein routing one or more mapping units through or around the target area comprises navigating through or around the target area using the one or more sensors of the one or more mapping units, optionally on the basis of a predetermined map of the target area.

9. A method according to any of claims 2 to 8, wherein routing one or more mapping units through or around the target area comprises following a predetermined path through or around the target area using the one or more sensors of the one or more mapping units.

10. A method according to any of claims 2 to 9, wherein the one or more mapping units are the one or more operating units.

11. A method according to any of claims 2 to 9, wherein the one or more mapping units are different from the one or more operating units.

12. A method according to any of claims 2 to 11, wherein the one or more mapping units are configurable for use as the one or more operating units, and vice versa.

13. A method according to any preceding claim, wherein mapping locations of crops in a target area further comprises locating the crops in relation to a known plan of the target area.

14. A method according to claim 13, further comprising receiving the plan of the target area.

15. A method according to any preceding claim, wherein mapping locations of the crops in the target area comprises identifying crops in the captured data.

16. A method according to claim 15, wherein mapping locations of the crops in the target area comprises identifying crops in the captured data using a trained model.

17. A method according to claim 16, further comprising using previously mapped locations of the crops in the target area as feedback for the trained model.

18. A method according to any preceding claim, wherein mapping locations of crops comprises generating a map of the located crops.

19. A method according to claim 18, wherein mapping locations of crops comprises generating a three dimensional map of the located crops; and optionally storing the three dimensional map as a point cloud.

20. A method according to claim 18 or 19, comprising, using the one or more operating units, obtaining a measure associated with the practical difficulty of operating on crops in at least part of the target area; and incorporating the measure into the generated map.

21. A method according to any of claims 18 to 20, further comprising updating the mapped locations of the crops in the target area based on a previously generated map and an expected growth rate.

22. A method according to claim 21, wherein said updating is further based on measured conditions in the growing environment.

23. A method according to any of claims 18 to 22, further comprising incorporating previously generated maps into the generated map.

24. A method according to any preceding claim, wherein mapping locations of crops in a target area comprises using historic mapped locations to assist in identifying crops in data captured by the mapping unit.

25. A method according to any preceding claim, further comprising, using the captured data, classifying the crops.

26. A method according to claim 25, further comprising generating a plurality of maps relating to different classifications of crops.

27. A method according to any of preceding claim, wherein the one or more sensors comprise one or more cameras; and the captured data is visual data.

28. A method according to claim 27, wherein the one or more cameras comprise a camera suitable for range imaging.

29. A method according to any preceding claim, wherein the one or more routes are efficient routes between at least some of the crops in the target area.

30. A method according to any preceding claim, wherein each operating unit comprises a mobile cart; and one or more crop manipulation devices mounted on the cart for operating on crops.

31. A method according to claim 30, wherein routing one or more operating units along the one or more routes comprises directing the movement of the cart; and directing the movement of the one or more crop manipulation devices.

32. A method according to claim 30 or 31, wherein generating one or more routes is further based on known parameters of the one or more operating units.

33. A method according to claim 32, wherein the known parameters comprise one or more typical speeds and/or times for the one or more operating units to perform one or more particular actions.

34. A method according to claim 33, wherein the one or more particular actions comprise one or more of: movement of the cart; and movement of the one or more crop manipulation devices.

35. A method according to any of claims 30 to 34, wherein the crop manipulation devices comprise robotic arms.

36. A method according to any preceding claim, wherein generating the one or more routes comprises determining an order in which at least some of the crops in the target area are to be harvested.

37. A method according to any preceding claim, wherein generating one or more routes comprises using a trained model.

38. A method according to any preceding claim, wherein generating routes comprises using one or more of: visibility graphs; random-exploring algorithms; probabilistic road maps; optimal search algorithms; following by example; and bioinspired algorithms.

39. A method according to any preceding claim, further comprising assigning the one or more routes to the one or more operating units.

40. A method according to claim 39, further comprising re-generating and/or re-assigning the one or more routes in dependence on detected issues with the one or more routes and/or the one or more operating units.

41. A method according to any preceding claim, wherein generating one or more routes is in dependence on one or more predetermined performance metrics.

42. A method according to any preceding claim, wherein operating on at least one of the crops comprises harvesting at least one of the crops.

43. A method according to claim 42, further comprising, at the location of each crop on the one or routes for a particular operating unit, directing a picking tool of the operating unit to the crop; and harvesting the crop.

44. A method according to claim 42 or 43, wherein harvesting the crop comprises one of: separating a crop-supporting part of a plant from the rest of the plant; and separating the crop from a plant.

45. A method according to any of claims 42 to 44, further comprising, using the one or more operating units, determining whether a particular crop on the one or more routes is ready for harvesting, wherein the particular crop is harvested based on an outcome of said determination.

46. A method according to claim 45, wherein determining whether a particular crop is ready to be harvested comprises collecting data related to the particular crop using a sensor.

47. A method according to any of claims 42 to 46, further comprising, using the captured data related to crops in a target area, determining whether a particular crop in the target area is ready for harvesting, wherein the particular crop is harvested based on an outcome of said determination.

48. A method according to any of claims 45 to 47, determining whether a particular crop is ready to be harvested further comprises comparing the collected data against a predetermined classifier relating to the readiness for harvest of crops.

49. A method according to any of claims 42 to 44, wherein the one or more operating units are arranged to harvest all of the crops on the one or more routes.

50. A method according to any of claims 42 to 44, wherein the one or more operating units are arranged to harvest all of the crops in the target area.

51. A method according to any preceding claim, further comprising collecting data related to crops using one or more sensors of the one or more operating units; and classifying the crops in dependence on data collected via said sensors.

52. A method according to any preceding claim, further comprising storing the harvested crops on the one or more operating units.

53. A method according to any preceding claim, further comprising transporting the harvested crops to a location for collection of the harvested crops.

54. A method according to claim 53, wherein transporting the harvested crops to a location for collection of the harvested crops comprises directing one or more transport units to the one or more operating units; transferring harvested crops onto the one or more transport units; and directing the one or more transport units to the location for collection of the harvested crops.

55. A method according to claim 54, further comprising scheduling use of the one or more transport units.

56. A method according to any preceding claim, further comprising weighing and/or sorting the harvested crops.

57. A method according to any preceding claim, further comprising classifying harvested crops according to weight and/or readiness for harvest.

58. A method according to any preceding claim, wherein operating on crops comprises one or more of: trimming; pruning; applying pesticides; planting; replanting; maintaining; clearing debris; and releasing bees.

59. A method according to any preceding claim, further comprising receiving a transmitted status from the one or more operating units; wherein the transmitted status relates to one or more of: location; load status; battery status; and errors or faults.

60. A method according to claim 59, further comprising, in response to the transmitted status, performing one or more of the following actions: rerouting the one or more operating units; directing the one or more transport units to the one or more operating units; directing the one or more operating units to a charging point; and directing one or more maintenance units to the one or more operating units.

61. A method according to any preceding claim, comprising routing one or more operating units along the one or more routes thereby to operate continuously on one or more of the crops on the one or more routes until a predetermined threshold is exceeded, wherein the threshold relates to one or more of: storage capacity; battery charge; maintenance status; and location within a route.

62. A method according to any preceding claim, further comprising scheduling use of the one or more operating units, optionally using a trained model.

63. A method according to claim 61, wherein said scheduling is in dependence on an external input, optionally wherein the external input is an indication of demand for crops.

64. A method according to any preceding claim, wherein the crops are harvested in a growing environment, optionally wherein the growing environment is a greenhouse having a pipe-rail heating system.

65. A method according to claim 64, wherein the target area is the entire growing environment.

66. A method according to any preceding claim, further comprising mapping the location of other objects of interest in a target area; wherein the other objects of interest are one or more of: obstacles; and parts of plants bearing the crops.

67. An operating unit for operating on crops in a growing environment, comprising:
a powered cart;
one or more robotic arms mounted on the cart, each arm having an end-effector for use in operating on crops; and
a processor for controlling movement of the cart and movement of the one or more robotic arms;
wherein the one or more robotic arms are arranged to position the end-effector with less than six degrees of freedom.

68. An operating unit according to claim 67, wherein the one or more robotic arms each have three axes of movement.

69. An operating unit according to claim 68, wherein the one or more robotic arms comprise cylindrical robotic arms.

70. An operating unit according to claim 68 or 69, wherein the one or more robotic arms comprise Cartesian robotic arms.

71. An operating unit according to any of claims 67 to 70, further comprising one or more sensors for receiving data relating to surrounding objects; wherein said data is used by the processor for navigating the cart through the growing environment.

72. An operating unit according to claim 71, wherein the one or more sensors comprise a camera and wherein the processor is configured to use computer vision to navigate the cart through the growing environment.

73. An operating unit according to claim 71 or 72, wherein the operating unit is arranged to move through or around a target area in the growing environment while capturing data thereby to map the target area.

74. An operating unit according to any of claims 71 to 73, wherein said data is used by the processor for fine positioning of the one or more robotic arms.

75. An operating unit according to any of claims 71 to 74, wherein said data is used by the processor and/or an external processor to determine whether a particular crop in the target area is ready for harvesting, optionally on the basis of a comparison against a predetermined classifier relating to the readiness for harvest of crops.

76. An operating unit according to any of claims 71 to 75, wherein at least one of said one or more sensors are mounted on the one or more robotic arms.

77. An operating unit according to any of claims 67 to 76, further comprising one or more odometers, wherein data received from said odometers is used by the processor for navigating the cart through the growing environment

78. An operating unit according to any of claims 67 to 77, further comprising a data store in communication with the processor.

79. An operating unit according to claim 78, wherein the data store comprises a model of the surroundings of the operating unit, optionally wherein the model includes a map of crops in a target area, wherein the processor is capable of using the model to control the movement of the cart and/or the one or more robotic arms.

80. An operating unit according to claim 78 or 79, wherein the data store comprises instructions for the operating unit, the instructions comprising: one or more routes for movement of the movement of the cart and/or the one or more robotic arms; and operation instructions for one or more crops.

81. An operating unit according to any of claims 67 to 80, comprising a plurality of end effectors which are generally interchangeable for use with the one or more robotic arms.

82. An operating unit according to any of claims 67 to 81, wherein possible operations on one or more crops comprise one or more of: harvesting the one or more crops; trimming; pruning; applying pesticides; planting; replanting; maintaining; clearing debris; and releasing bees.

83. An operating unit according to claim 82, wherein harvesting comprises one or more of: picking; cutting; grinding; squeezing; crushing; and shaking.

84. An operating unit according to any of claims 67 to 83, further comprising means for storing harvested crops, preferably wherein the means for storing harvested crops is refrigerated, and optionally wherein the means for storing includes means for weighing and sorting the crops.

85. An operating unit according to any of claims 67 to 84, further comprising means for co-operating with a further unit or storage mechanism to allow crops to be offloaded.

86. An operating unit according to any of claims 67 to 85, further comprising communication means in communication with the processor, wherein the operating unit is arranged to transmit data related to operation on crops to an external server and receive data from the external server.

87. An operating unit according to any of claims 67 to 86, wherein the operating unit is configured to operate in accordance with a predetermined schedule.

88. An operating unit according to any of claims 67 to 87, further comprising a GPS receiver; optionally wherein the operating unit is arranged to transmit an indication of location to a server.

89. An operating unit according to any of claims 67 to 88, further comprising one or more light sources.

90. An operating unit according to any of claims 67 to 89, further comprising a battery for powering the operating unit.

91. A mapping unit for capturing data related to crops in a target area in a growing environment, comprising:
a powered cart;
a processor for controlling movement of the cart; and
one or more sensors mounted on the cart;
wherein the mapping unit is arranged to move through or around a target area in the growing environment while capturing data using the one or more sensors thereby to capture data related to crops in a target area.

92. A mapping unit according to claim 91, wherein the one or more sensors are arranged to be capable of capturing visual data from more than one side of the cart.

93. A mapping unit according to claim 91 or 92, wherein the one or more sensors are movable.

94. A mapping unit according to any of claims 91 to 93, wherein the one or more sensors are mounted on a movable platform on the cart.

95. A mapping unit according to any of claims 91 to 94, comprising a plurality of sensors.

96. A mapping unit according to any of claims 91 to 95, wherein the one or more sensors comprise a camera; optionally a camera suitable for range imaging.

97. A mapping unit according to any of claims 91 to 96, wherein captured data is further used by the processor for navigating the cart through the growing environment; optionally using computer vision.

98. A mapping unit according to any of claims 91 to 97, further comprising one or more odometers, wherein data received from said odometers is used by the processor for navigating the cart through the growing environment.

99. A mapping unit according to any of claims 91 to 98, wherein the mapping unit is configured to operate in accordance with a predetermined schedule.

100. A mapping unit according to any of claims 91 to 99, further comprising a battery for powering the mapping unit.

101. A mapping unit according to any of claims 91 to 100, further comprising one or more light sources.

102. A mapping unit according to any of claims 91 to 101, further comprising communication means in communication with the processor; wherein the operating unit is arranged to transmit captured data to a server.

103. A mapping unit according to any of claims 91 to 102, further comprising a GPS receiver; optionally wherein the operating unit is arranged to transmit an indication of location to a server.

104. A system for mapping locations of crops in a target area; comprising:
one or more mapping units according to claim 102 or 103; and
a server;
wherein the server is configured to identify crops in the visual data captured by the one or more mapping units and locate the identified crops in relation to a known plan of the target area and/or the locations of the one or more mapping units thereby to map the location of crops in the target area.

105. A transport unit for transporting harvested crops in a growing environment, comprising:
a powered cart;
a processor for controlling movement of the cart; and
one or more containers for transporting crops;
wherein the transport unit is configured to shuttle between a generally variable first location and a generally fixed second location thereby to transport harvested crops from the first location to the second location.

106. A transport unit according to claim 105, wherein the generally variable first location is the location of an operating unit, optionally an operating unit according to any of claims 67 to 90.

107. A transport unit according to claim 106, further comprising means for co-operating with the operating unit to assist in transferring crops from the operating unit to the transport unit.

108. A transport unit according to any of claims 105 to 107, further comprising wireless communication means for receiving an indication of location from the operating unit, optionally via a server.

109. A transport unit according to any of claims 105 to 108, wherein the generally fixed second location is a dock, optionally comprising a server.

110. A transport unit according to any of claims 105 to 109, further comprising a data store and a physical interface to allow for external computing devices to communicate with the data store; wherein the transport unit is arranged to transfer data between the first location and second location.

111. A transport unit according to any of claims 105 to 110, further comprising one or more sensors for capturing data related to surrounding objects, wherein captured data is used by the processor for navigating the cart through the growing environment; optionally using computer vision.

112. A transport unit according to any of claims 105 to 111, further comprising one or more odometers, wherein data received from said odometers is used by the processor for navigating the cart through the growing environment

113. A transport unit according to any of claims 105 to 112, further comprising means for weighing and sorting the crops.

114. A transport unit according to any of claims 105 to 113, further comprising means for inspecting harvested crops, optionally for readiness for harvest.

115. A transport unit according to any of claims 105 to 114, wherein the transport unit is configured to operate in accordance with a predetermined schedule.

116. A transport unit according to any of claims 105 to 115, further comprising a GPS receiver; optionally wherein the transport unit is arranged to transmit an indication of location to a server.

117. A transport unit according to any of claims 105 to 116, further comprising one or more light sources.

118. A transport unit according to any of claims 105 to 117, further comprising a battery for powering the transport unit.

119. A maintenance unit for use with one or more autonomous units for operating on crops in a growing environment, comprising:
a powered cart;
one or more robotic arms mounted on the cart, each arm having an end-effector for use in operating on one or more autonomous units; and
a processor for controlling movement of the cart and movement of the one or more robotic arms;
wherein the maintenance unit is arranged to perform maintenance operations on the one or more autonomous units.

120. A maintenance unit according to claim 119, wherein the maintenance operations comprise one or more of: unscrewing/rescrewing panels; changing a component; charging a battery; re-wiring; changing a tyre/wheel; mending a puncture; cleaning (for example, cleaning a camera); and removing blockages.

121. A maintenance unit according to claim 119 or 120, further comprising one or more sensors for capturing data related to surrounding objects, wherein captured data is used by the processor for navigating the cart through the growing environment; optionally using computer vision.

122. A maintenance unit according to claim 121, wherein captured data is further used by the processor to identify units requiring maintenance, optionally using a trained model.

123. A maintenance unit according to any of claims 119 to 122, further comprising one or more odometers, wherein data received from said odometers is used by the processor for navigating the cart through the growing environment.

124. A maintenance unit according to any of claims 119 to 123, further comprising a GPS receiver; optionally wherein the maintenance unit is arranged to transmit an indication of location to a server.

125. A maintenance unit according to any of claims 119 to 124, further comprising one or more light sources.

126. A maintenance unit according to any of claims 119 to 125, wherein the maintenance unit is capable of maintaining itself.

127. A dock for one or more autonomous units; wherein the one or more autonomous units comprise one or more of: an operating unit according to any of claims 67 to 90; a mapping unit according to any of claims 91 to 103; a transport unit according to any of claims 105 to 118; and a maintenance unit according to any of claims 119 to 126.

128. A dock according to claim 127, wherein the dock is arranged to store the autonomous units when not in use.

129. A dock according to claim 127 or 128, wherein the dock is arranged to receive harvested crops from the one or more autonomous units.

130. A dock according to any of claims 127 to 129, wherein the dock is arranged to supply power to the one or more autonomous units.

131. A growing environment, comprising a plurality of rows of frames for growing plants; and a plurality of navigation aids to assist autonomous units with navigation through the plurality of rows.

132. A growing environment according to claim 131, wherein the plurality of navigation aids comprise any or all of: position markers; guide wires; colour coded areas; magnetic strips; backdrops for crops; and visible tags/barcodes applied to obstacles and/or plants.

133. A growing environment according to claim 131 or 132, further comprising one or more cameras for monitoring the growing environment.

134. A growing environment according to any of claims 131 to 133, further comprising means for conveying objects out of the growing environment.

135. A growing environment according to any of claims 131 to 134, further comprising a plurality of wired network access points for the autonomous units; the network access points being spread throughout the growing environment.

136. A growing environment according to any of claims 131 to 135, wherein the plurality of rows of frames are movable relative to each other thereby to allow adjustment of the width of the interstitial spaces between rows.

137. A growing environment according to any of claims 131 to 136, wherein the plurality of rows of frames are moveable relative to each other thereby to allow adjustment of the vertical position of each row.

138. A growing environment comprising a plurality of rows of frames for growing plants, wherein the plurality of rows of frames are movable relative to each other thereby to allow adjustment of the vertical position of each row and the width of the interstitial spaces between rows.

139. A growing environment according to any of claims 131 to 138, wherein the growing environment is a greenhouse.

140. A system for harvesting crops in a target area, comprising:
one or more operating units for harvesting crops in a target area;
a dock for receiving harvested crops; and
one or more transport units for transporting harvested crops from the one or more operating units to the dock.

141. A system according to claim 140, wherein the one or more transport units are configured to navigate to a transmitted location of the one or more operating units.

142. A system according to claim 140 or 141, wherein the one or more operating units comprise one or more operating units according to claims 67 to 90.

143. A system according to any of claims 140 to 142, wherein the one or more transport units comprise one or more transport units according to claims 105 to 118.

144. A system according to any of claims 140 to 143, wherein the dock comprises a dock according to claims 127 to 130.

145. A system for operating on crops in a target area, comprising:
one or more operating units for operating on crops;
one or more mapping units capturing data related to crops in a target area;
a processor for mapping locations of the crops in the target area using the captured sensor data; generating one or more routes between at least some of the crops in the target area based on the mapped locations; and for routing the one or more operating units along the one or more routes thereby to operate on at least one of the crops on the one or more routes.

146. A system according to claim 145, wherein the one or more operating units comprise one or more operating units according to any of claims 67 to 90.

147. A system according to claim 145 or 146, wherein the one or more mapping units comprise one or more mapping units according to any of claims 91 to 103.

148. A system according to any of claims 145 to 147, further comprising a dock for receiving harvested crops, optionally wherein the processor is located in the dock.

149. A system according to claim 148, wherein the dock comprises a dock according to any of claims 127 to 130.

150. A system according to any of claims 145 to 149, further comprising one or more transport units for transporting harvested crops from the one or more operating units to the dock.

151. A system according to claim 150, wherein the one or more transport units comprise one or more transport units according to any of claims 105 to 118.

152. A system according to claim 150 or 151, wherein the one or more transport units are arranged to communicate data between the units and the dock via physical data connections.

153. A system according to any of claims 145 to 152, further comprising one or more maintenance units for maintaining the one or more operating units; the one or more mapping units; and/or the one or more transport units.

154. A system according to claim 153, wherein the one or more maintenance units comprise one or more maintenance units according to any of claims 105 to 118.

155. A system according to any of claims 145 to 154, further comprising communication means provided in communication with the processor; wherein each of the units comprise communication means for receiving data from the processor.

156. A system according to any of claims 145 to 155, wherein all of the units comprise a mobile cart, such that the units are interchangeable and modular.

157. A system according to any of claims 145 to 156, configured to implement the method of any of claims 1 to 66.

158. A system according to any of claims 145 to 156, wherein the target area is within a growing environment according to any of claims 131 to 139.

159. A method according to any of claims 1 to 66, wherein the one or more operating units are one or more operating units according to any of claims 68 to 88.

160. A method according to claim 2 or any of claims 3 to 66 when dependent on claim 2, wherein the one or more mapping units are one or more mapping units according to any of claims 91 to 103.

161. A method according to any of claims 1 to 66 or claim 159 or 160, wherein the target area is within a growing environment according to any of claims 131 to 139.

162. A computer program product comprising software code adapted to carry out the method of any of claims 1 to 66 or claims 159 to 161.
